(19) United States
(12) Patent Application Publication
(10) Pub. No.: US 2026/0187234 A1
(43) Pub. Date: Jul. 2, 2026

(54) PREVENTING CONSUMPTION OF INCORRECT DATA CAUSED BY SILENT DROP OF TRUSTED WRITE FROM TRUSTED INPUT/OUTPUT DEVICES TO PRIVATE MEMORY OF TRUSTED VIRTUAL MACHINE

(71) Applicants: Shalini SHARMA, Folsom, CA (US); Filip SCHMOLE, Portland, OR (US); Arie AHARON, Portland, OR (US); Raghunandan MAKARAM, Northborough, MA (US); Varun JANNEPALLY, Portland, OR (US)

(72) Inventors: Shalini SHARMA, Folsom, CA (US); Filip SCHMOLE, Portland, OR (US); Arie AHARON, Portland, OR (US); Raghunandan MAKARAM, Northborough, MA (US); Varun JANNEPALLY, Portland, OR (US)

(21) Appl. No.: 19/004,202

(22) Filed: Dec. 27, 2024

(51) Int. Cl. G06F 21/55; G06F 21/53; G06F 21/85

(52) U.S. Cl. CPC G06F 21/554; G06F 21/53; G06F 21/85

(57) ABSTRACT

An apparatus of an aspect includes a controller to receive a first trusted write from at least a portion of a trusted input/output (IO) device. The apparatus also includes an IO processor coupled with the controller. The IO processor to drop the first trusted write and block, based on the first trusted write being dropped, a subsequent trusted write from said at least the portion of the trusted IO device. Other apparatus, methods, and systems are also disclosed.

### BACKGROUND

### Technical Field

Embodiments described herein generally relate to trusted input/output. In particular, embodiments described herein generally relate to preventing data corruption during trusted input/output.

### Background Information

The Peripheral Component Interconnect Special Interest Group (PCI-SIG) TEE Device Interface Security Protocol (TDISP), Revision 5.x, released Aug. 11, 2022, describes in part an architecture for trusted I/O virtualization where a trusted input/output (IO) device may communicate with a trusted virtual machine (TVM).

### BRIEF DESCRIPTION OF THE DRAWINGS

Various examples in accordance with the present disclosure will be described with reference to the drawings, in which:

FIG. 1 is a block diagram of an embodiment of a system including a trusted IO host coupled with a trusted IO device.

FIG. 2 is a block diagram of another embodiment of a system including a trusted IO host coupled with a trusted IO device.

FIG. 3 is a block diagram of an embodiment of a chip.

FIG. 4 is a block flow diagram of an embodiment of a method.

FIG. 5 is a block diagram of another embodiment of a system including a trusted IO host coupled with a trusted IO device.

FIG. 6 is a block diagram of a first example embodiment of an IO processor having circuitry to block at least all trusted writes from one or more TDIs that have corresponding requester identifiers that are specified.

FIG. 7 is a block diagram of a second example embodiment of an IO processor having circuitry to block at least all trusted writes from one or more streams that have corresponding stream identifiers that are specified.

FIG. 8 is a block diagram of a third example embodiment of an IO processor having circuitry to mask, filter, or otherwise block at least all trusted writes from all attached trusted IO devices.

FIG. 9 is a block flow diagram of an embodiment of a method that may be performed by a TSM to unbind a portion of trusted IO device and cause an IO processor to stop blocking trusted transactions from the portion of the trusted IO device.

FIG. 10 illustrates an example computing system.

FIG. 11 illustrates a block diagram of an example processor and/or System on a Chip (SoC) that may have one or more cores and an integrated memory controller.

FIG. 12(A) is a block diagram illustrating both an example in-order pipeline and an example register renaming, out-of-order issue/execution pipeline according to examples.

FIG. 12(B) is a block diagram illustrating both an example in-order architecture core and an example register renaming, out-of-order issue/execution architecture core to be included in a processor according to examples.

FIG. 13 illustrates examples of execution unit(s) circuitry.

FIG. 14 is a block diagram of a register architecture according to some examples.

FIG. 15 illustrates examples of an instruction format.

FIG. 16 illustrates examples of an addressing information field.

FIG. 17 illustrates examples of a first prefix.

FIGS. 18(A)-(D) illustrate examples of how the R, X, and B fields of the first prefix in FIG. 17 are used.

FIGS. 19(A)-(B) illustrate examples of a second prefix.

FIG. 20 illustrates examples of a third prefix.

FIG. 21 is a block diagram illustrating the use of a software instruction converter to convert binary instructions in a source instruction set architecture to binary instructions in a target instruction set architecture according to examples.

### DETAILED DESCRIPTION OF EMBODIMENTS

The present disclosure relates to methods, apparatus, systems, and non-transitory computer-readable storage media to prevent consumption of incorrect data caused by silent drop of trusted write from trusted input/output devices to private memory of trusted virtual machine. In the following description, numerous specific details are set forth (e.g., specific sequences of operations, standards, processor configurations, microarchitectural details, etc.). However, embodiments may be practiced without these specific details. In other instances, well-known circuits, structures, and techniques have not been shown in detail to avoid obscuring the understanding of the description.

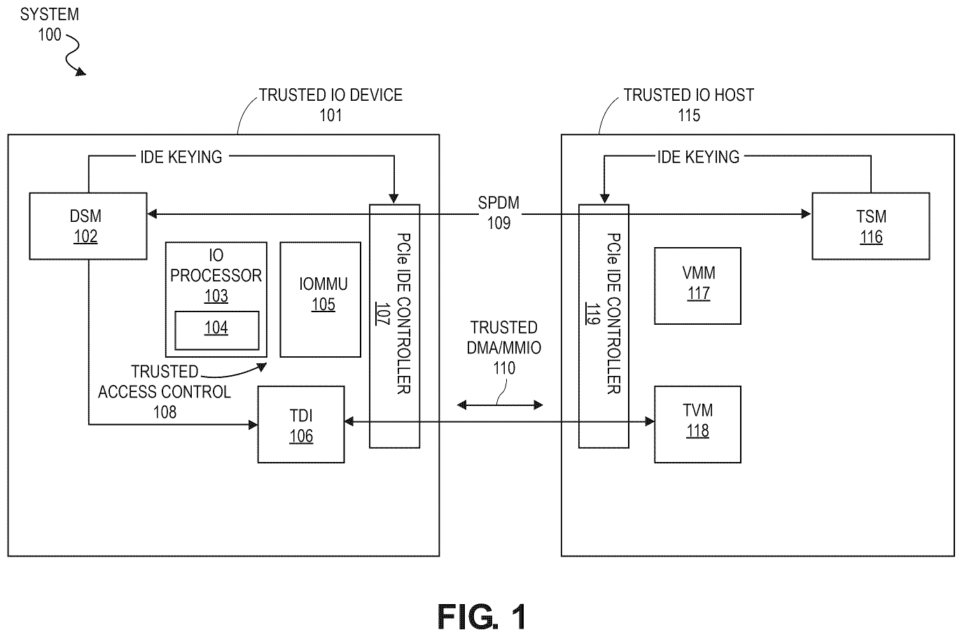

FIG. 1 is a block diagram of an embodiment of a system 100 including a trusted input/output (IO) host 115 coupled with a trusted IO device 101. The TDISP architecture describes components and protocols to allow the trusted IO host and the trusted IO device to perform trusted IO (e.g., trusted direct memory access (DMA), trusted memory-mapped input/output (MMIO), or the like).

In some embodiments, the trusted IO may be performed according to Intel® Trust Domain Extensions Connect (TDX Connect). In other embodiments, the trusted IO may be performed according to AMD's Secure Encrypted Virtualization (SEV) Trusted I/O (SEV-TIO). In still other embodiments, the trusted IO may be performed according to ARM Realm Management Extension Device Assignment (RME-DA).

The trusted IO host includes a virtual machine monitor (VMM) 117, at least one trusted virtual machine (TVM) 118, a trusted execution environment (TEE) Security Manager (TSM) 116, and a Peripheral Component Interconnect Express (PCIe) Integrity and Data Encryption (IDE) controller 119. The trusted IO device includes a Device Security Manager (DSM) 102, an IO processor 103, an input-output memory management unit (IOMMU) 105, a TEE Device Interface (TDI) 106, and a PCIe IDE controller 107. The IO processor, the IOMMU, and the PCIe IDE controller represent trusted IO access control 108. The PCIe IDE controllers may be coupled with one another via intervening fabric or other interconnects as well as intervening switches or other such devices. The IO processor has circuitry configurable to block a write to a completion indicator, as will be discussed further below.

The VMM may manage resources of the trusted IO host and may help to support the TVM. One example of a suitable TVM for some embodiments is a trust domain in Intel® Trust Domain Extensions (Intel® TDX). Another example of a suitable TVM for some embodiments is a Secure Encrypted Virtualization Secure Nested Paging (SEV-SNP) virtual machine in AMD SEV-SNP. Yet another example of a suitable TVM for some embodiments is a realm in ARM RME. In other embodiments, the TVM may be replaced by other secure environments, such as, for example, a secure enclave (e.g., which need not necessarily be a virtual machine). The TVM may execute within a Trusted Execution Environment (TEE) or a secure area of the processor (not shown) of the trusted IO host. The TEE may guarantee that code and data loaded therein will be protected with respect to confidentiality and integrity. Resources of the trusted IO device may be directly assigned to the TVM. For example, the TDI may be assigned to the TVM. The TDI represents a unit of assignment for an IO-virtualization (IOV) capable device. For example, a TDI may be the entire trusted IO device, a non-IOV Function, or a virtual function. The TDI may provide device functions to the TVM.

The TSM is in the trusted computing base (TCB) of the TVM. One example of a suitable TSM for some embodiments is a TDX module in Intel TDX. Another example of a suitable TSM for some embodiments is the AMD Secure Processor (ASP) in AMD SEV-SNP. Yet another example of a suitable TSM for some embodiments is a realm management monitor (RMM) in ARM RME. The TSM may manage and enforce security policies on the trusted IO host and help to protect the TVM from the VMM and other untrusted software. The DSM may manage and enforce security policies on the trusted IO device and manage the security state of the TDI. The DSM may be admitted into the TCB of the TVM by the TSM if authorized by the TVM. The TVM may be responsible for accepting the TDI. Before the TVM accepts a TDI, only the TSM and the host processor may be in the TCB of the TVM. Once the TVM accepts a TDI, the TVM extends its TCB to the DSM. The VMM may be responsible for attaching a TDI accepted by the TVM and detaching the TDI from the TVM.

The TSM and the DSM may communicate via a Secure Protocol and Data Model (SPDM) protocol. SPDM is a request-response message protocol and may serve as the control path through which the TSM may access and manage TDISP features of the trusted IO device. The TSM and DSM may protect the SPDM connection by negotiating keys and establishing a SPDM Secure Messages session that encrypts and authenticates SPDM messages. The PCI IDE protocol may serve as the data path for trusted IO between the trusted IO device and the trusted IO host. The IDE protocol may encrypt and authenticate device traffic in an end-to-end stream where only the root port of the trusted IO host and the trusted IO device possess the IDE stream keys. This may help to keep data transmitted between the trusted IO device and the trusted IO host confidential. The TSM and the DSM may negotiate the keys used for IDE keying via the SPDM channel.

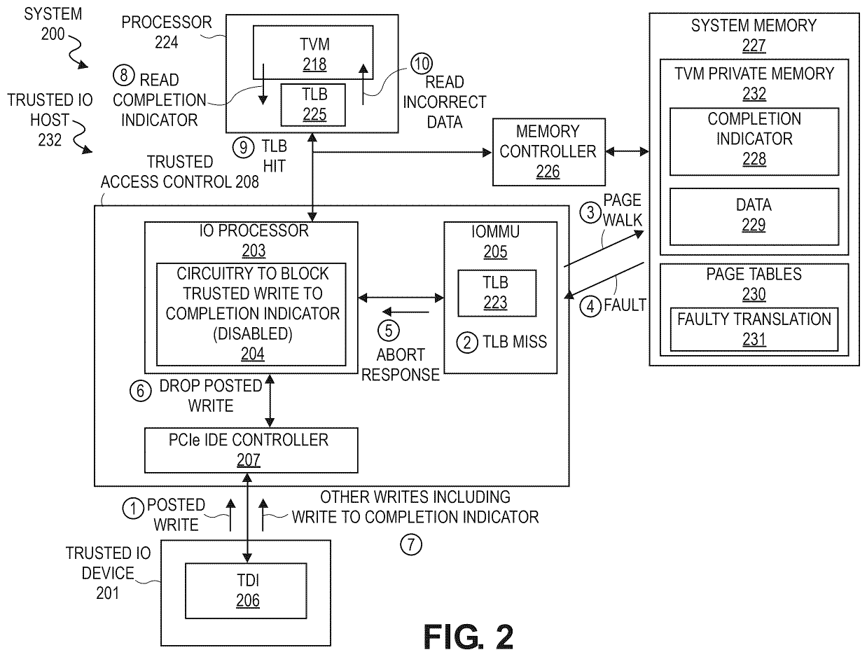

FIG. 2 is a block diagram of an embodiment of a system 200 including a trusted IO host 232 coupled with a trusted IO device 201. The trusted IO host and the trusted IO device may perform trusted IO. In some embodiments, the trusted IO may be according to Intel® TDX Connect. In other embodiments, the trusted IO may be according to AMD's SEV-TIO.

The trusted IO host 232 includes a processor 224 to support and execute instructions of a TVM 218 and other software (e.g., a VMM, not shown). The processor may have or offer a trusted execution environment (TEE) to support the TVM. The processor has a translation lookaside buffer (TLB) 225.

The trusted IO host also includes trusted IO access control 208 coupled with the processor. The trusted IO access control includes a PCIe IDE controller 207, an IO processor 203 coupled with the PCIe IDE controller, and an IOMMU 205 coupled with the IO processor. The IO processor includes circuitry 204 to block a trusted write to a completion indicator. However, in the illustrated embodiment of FIG. 2 the circuitry 204 is in a disabled or turned-off state where it will not block the trusted write to the completion indicator. This disabled state is used to illustrate potential problems (e.g., consumption of incorrect data) that may occur if the circuitry 204 is not present or is disabled. The IOMMU includes a TLB 223.

The trusted IO device 201 is coupled with the PCIe IDE controller 207. As previously shown in FIG. 1, the trusted IO device may also include its own PCIe IDE controller (not shown) to couple with the PCIe IDE controller 207. The trusted IO device includes a TDI 206. Additional or many other TDIs (not shown) may also optionally be included.

The trusted IO host also includes a memory controller 226 and a system memory 227 coupled with the memory controller. The memory controller is coupled with the processor 224 and coupled with the trusted IO access control 208 to allow the processor, the trusted IO access control, and the trusted IO device to access the system memory. The system memory includes TVM private memory 232 that is private to the TVM 218. The TVM, the TDI 206 (once accepted by the TVM), and other entities trusted by the TVM may be able to access the TVM private memory. However, a VMM (not shown) and other entities not trusted by the TVM may not be able to access the TVM private memory.

The TVM private memory includes data 229. The data 229 may be shared by the trusted IO host and the trusted IO device. For example, the data 229 may include data written into the private memory of the TVM by the trusted IO device. By way of example, the TVM may offload, submit, or otherwise send work or other processing to the trusted IO device (e.g., to the TDI 206). The TVM may specify a location of the data 229 (e.g., a DMA buffer) in the TVM private memory. The trusted IO device may perform the work and then store the data 229 to the memory. Thereafter, the TVM may access the data 229.

The TVM private memory also includes a completion indicator 228 (e.g., a semaphore, a flag, a value used for synchronization between the TVM and the trusted IO device, etc.). The completion indicator may allow the trusted IO host and the trusted IO device to communicate about and/or synchronize on the data 229. By way of example, the trusted IO device may write to, update, or change the completion indicator to indicate that the work or other processing it was assigned has been completed and/or to indicate that the data 229 is available in the TVM private memory for the TVM to access it. The TVM may poll on or otherwise check the completion indicator to observe when it has been written to, updated, or changed. Once the completion indicator has been updated or changed the TVM may access the data 229. The TVM may wait for the completion indicator to be written to, updated, or changed before accessing the data 229. The TVM may implement a timeout mechanism that may cause a timeout if the completion indicator isn't written in a predetermined, threshold, or certain amount of time.

The system memory also includes page tables 230. The page tables contain translations of virtual addresses to host physical addresses that address locations in the system memory 227. The TLB 225 may cache or store some such translations of guest virtual addresses used by software (e.g., the TVM) to host physical addresses. When the processor needs such translations, it may first check the TLB 225 to see if it has the needed translations. If not, then a memory management unit (MMU) of the processor may perform page table walks to obtain the needed translations from the page tables 230. Similarly, the TLB 223 may cache or store some translations of device virtual addresses used by the trusted IO device to host physical addresses. When the trusted IO device needs such translations, it may first check the TLB 223 to see if the needed translations are stored therein. If not, then the IOMMU 205 may perform page table walks to obtain the needed translations from the page tables.

To further illustrate certain concepts, FIG. 2 illustrates a potential problem that may occur when the circuitry 204 is disabled or is absent. Initially, the TVM (e.g., a device driver thereof) may submit work or other processing to at least a portion of the trusted IO device. In this example, the portion is the TDI 206.

As shown at an encircled one (1), as part of performing the work or processing, the TDI may perform a trusted posted write (e.g., a trusted posted DMA write) to the data 229 in the TVM private memory 232. Trusted writes may be used to write to the TVM private memory. For example, when a TDISP device is in a state in which it is generating trusted transactions then IDE packets may have a prefix having T bit that is set to binary one to indicate that the IDE packet is trusted and needs to be protected. Untrusted writes may use IDE packets where the T bit is cleared to binary zero. The posted write may represent a submit-and-forget type of write that may be submitted, and expected to be completed, but there may be no acknowledgement whether the write has actually been completed.

The PCIe IDE controller 207 may receive the trusted posted write and may provide the trusted posted write to the IO processor 203. The IO processor may track transactions and/or IO requests from attached IO devices. The IO processor may attempt to obtain an address translation of a device virtual address corresponding to the trusted posted write to a host physical address of the location of the data 229 being written. This may include requesting the needed translation from the IOMMU 205.

As shown at an encircled two (2), the IOMMU may check the TLB 223 to see if the needed translation is stored in the TLB 223 and there may be a TLB miss. Such TLB misses will be encountered some of the time (e.g., if the needed translation has not been used or has not been used recently so it has been evicted from the TLB 223).

As shown at an encircled three (3), the IOMMU 205 may perform a page table walk in the page tables 230 to attempt to obtain the needed translation. Assume for this illustrative example that the needed translation is a faulty translation 231 in the page tables. The faulty translation may have some error that prevents the page table walk from returning the needed address translation. For example, in some cases, the error may be due to a soft error (e.g., caused by cosmic radiation erroneously flipping a value of a bit of the faulty translation). In other cases, the error may be due to the VMM inadvertently or accidentally introducing the error in the translation. However, in other cases, the error in the translation data may potentially be caused deliberately by an untrusted entity in conjunction with a security attack. For example, an attacker may use a corrupted VMM to change the page tables to attempt to steal secrets of the TVM. The VMM is untrusted by the TVM (e.g., outside of its trusted computing base) and so the TVM cannot trust or rely on the VMM to fix the faulty translation.

As shown at an encircled four (4), a fault may be signaled to the IOMMU 205 (e.g., by the memory controller 226). The fault may represent a page fault, other type of fault, access violation, or other such exceptional condition preventing the needed translation from being returned. As one example, the IOMMU may receive a poison indication from the memory controller due to a TVM owner mismatch. Commonly, the IOMMU may log the fault.

As shown at an encircled five (5), the IOMMU may send an abort response to the IO processor. The abort response may represent an unsuccessful return, an indication that the needed translation could not be obtained, or the like.

As shown at an encircled six (6), the IO processor may drop the trusted posted write based on the abort response and/or since the needed translation was not returned. One challenge is that the trusted posted write may be dropped “silently” without the TVM knowing that the trusted posted write was dropped. The trusted IO device may be aware that the trusted posted write was dropped and may even log or record that it was dropped. However, the TVM may not be informed that the trusted posted write was dropped. Although the trusted posted write is described as being dropped herein due to the faulty translation and/or the abort response, it is to be appreciated that the trusted posted write may also potentially be dropped due to other reasons, such as, for example, due to a hardware failure, a communication error, an inability of the IO processor to accept another write, etc. Also, although the trusted posted write is described herein as being dropped it is to be appreciated that other writes or other transactions may also be silently dropped.

As shown at an encircled seven (7), the trusted IO device may not shut down or stop operating as a result of the dropped posted write, but rather the trusted IO device may perform other writes to the data 229 and ultimately may perform a trusted write to update or change the completion indicator 228 to indicate that the data 229 is available in the TVM private memory and is ready for the TVM to access it.

As shown at an encircled eight (8), the TVM may poll or otherwise read the completion indicator 228. Since the write to the completion indicator was performed as shown at encircled seven (7), the completion indicator will have been changed or updated to indicate that the data 229 is ready.

As shown at an encircled nine (9), the TVM may attempt to access the data 229 and may get a TLB hit in the TLB 225 for the needed translation. Such TLB hits will be encountered some of the time (e.g., if the TVM had recently read from the same host physical address). The needed translation in the TLB 225 is correct and does not reflect the error that subsequently happened to create the faulty translation 231. That is, the TLB 225 and the page tables having the faulty translation 231 are not synchronized. This desynchronization means that the processor may continue to operate using the old translation lacking the error obtained from the TLB 225 without being aware of the faulty translation 231.

As shown at an encircled ten (10), the TVM may read the incorrect data 229. The data 229 is incorrect because the data 229 was unintentionally not modified by the dropped posted write, although it should have been. This may cause the data 229 to have an incorrect value and/or a value erroneously different from what it should be if the trusted posted write was not dropped. This may represent a significant problem, since the TVM may not be aware that the data 229 is incorrect and may continue to process the incorrect data and potentially share the incorrect data or results derived therefrom with other entities further compounding the problem.

A similar problem may also arise in a different scenario where two different trusted IO devices exchange data. For example, a first trusted IO device may have a producer TDI that produces data in private memory and a second trusted IO device may have a consumer TDI that consumes the data in the private memory produced by the producer TDI. The producer TDI may issue a trusted posted write that similarly gets silently dropped without the consumer TDI knowing about it. Similarly, the consumer TDI may in certain cases access the resulting incorrect data from the private memory.

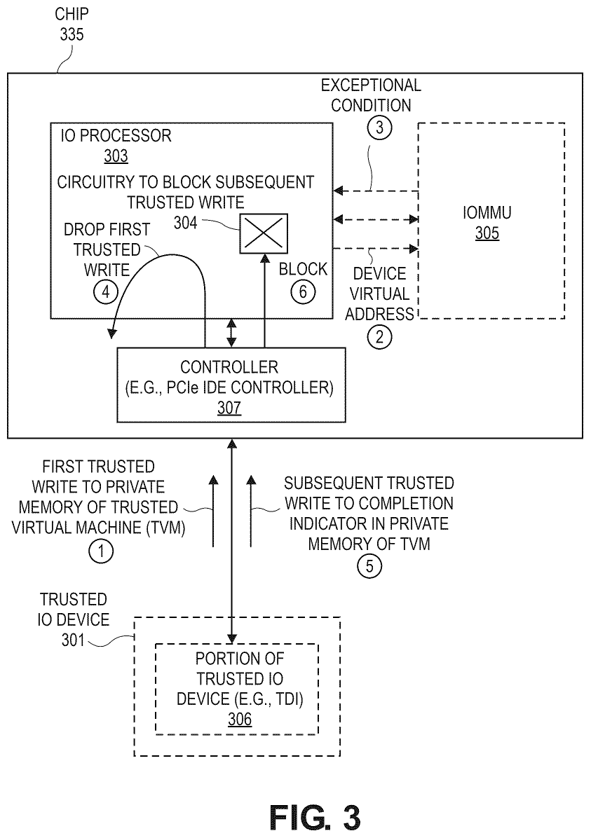

FIG. 3 is a block diagram of an embodiment of a chip 335 (e.g., a system-on-a-chip (SoC). The chip includes a controller 307. In some embodiments, the controller may be a Peripheral Component Interconnect Express (PCIe) Integrity and Data Encryption (IDE) controller. As shown at an encircled one (1), the controller may receive a first trusted write, from at least a portion 306 of a trusted IO device 301, to private memory of a TVM. In some embodiments, the first trusted write may be a trusted posted write. In some embodiments, the portion 306 of the trusted IO device may be a TDI.

The chip also includes an IO processor 303 coupled with the controller. The IO processor may receive the first trusted write from the controller. The IO processor may attempt to obtain an address translation for the first trusted write. As shown at an encircled two (2), the IO processor may provide a device virtual address to an IOMMU to request the address translation. The IOMMU may attempt to translate the device virtual address to a host physical address. In some embodiments, as shown at an encircled three (3), the IOMMU may not be able to obtain the address translation (e.g., if there is a faulty translation in page tables) and may signal a fault or exceptional condition to the IO processor. As shown at an encircled four (4), the IO processor may drop the first trusted write based on the exceptional condition. Alternatively, the IO processor may drop the first trusted write for other reasons besides due to such a fault or exceptional condition. For example, the first trusted write may be dropped due to a hardware failure, a communication error, an inability of the IO processor to accept another write, etc.

As shown at an encircled five (5), the controller may receive a second, subsequent trusted write from the portion 306 of the trusted IO device 301 to a completion indicator in the private memory of the TVM. The subsequent trusted write occurs chronologically after the first trusted write. The IO processor may receive the subsequent trusted write from the controller.

As shown at an encircled six (6), the IO processor may block, based on the first trusted write being dropped, the second, subsequent trusted write. Blocking the second, subsequent trusted write may include preventing it from being sent to the completion indicator such that the completion indicator will not be updated or changed. This blocks the indication from the trusted IO device to the TVM that data is available and ready for the TVM to access it. As a result, the TVM may continue to wait for the write to the completion indicator and may not consume the data. This may help to prevent the TVM from reading and using incorrect data caused by the drop of the first trusted write. In some embodiments, the TVM may optionally implement a timeout on the write to the completion indicator. For example, a counter may count (e.g., increment or decrement) from a starting value toward a certain value (e.g., a predetermined value, a threshold value, etc.). If that certain value is reached before the write to the completion indicator occurs or is detected then the TVM may be alerted and some corrective action may be taken. In this way, the blocking of the write to the completion indicator may serve to communicate the silent drop of the first trusted write to the TVM so that the TVM does not use incorrect data resulting from the silent drop of the first trusted write.

Blocking the second, subsequent trusted write may be done in different ways in different embodiments. In some embodiments, the second, subsequent trusted write may optionally be selectively blocked or prevented without blocking or preventing other trusted writes from the same portion 306 of the trusted IO device. For example, such selectivity may be achieved by blocking based in part on an address or memory location of the completion indicator. For example, trusted writes to addresses of the data 229 may optionally be allowed whereas the trusted write to the address of the completion indicator 228 may be selectively blocked or prevented.

In other embodiments, the IO processor may optionally block or prevent, based on the first trusted write being dropped, all trusted writes from the portion 306 of the trusted IO device to the private memory of the TVM after the drop of the first trusted write. In still other embodiments, the IO processor may optionally block or prevent, based on the first trusted write being dropped, all trusted writes received after the first trusted write over an Integrity and Data Encryption (IDE) selective stream over which the first trusted write was received. In yet embodiments, the IO processor may optionally block or prevent, based on the first trusted write being dropped, all trusted writes from all the trusted IO devices under that IO processor to the private memory of the TVM after the drop of the first trusted write. In any of the different embodiments mentioned in this paragraph, the IO processor may optionally also block or prevent all trusted reads to the private memory of the TVM. In any of the different embodiments mentioned in this paragraph, the IO processor may optionally also block or prevent all completions for trusted MMIO reads by the TVM to the portion of the trusted device (e.g., to a completion indicator within a TDI). In any of the different embodiments mentioned in this paragraph, the IO processor may optionally not block or prevent non-trusted writes (e.g., to locations outside the private memory of the TVM).

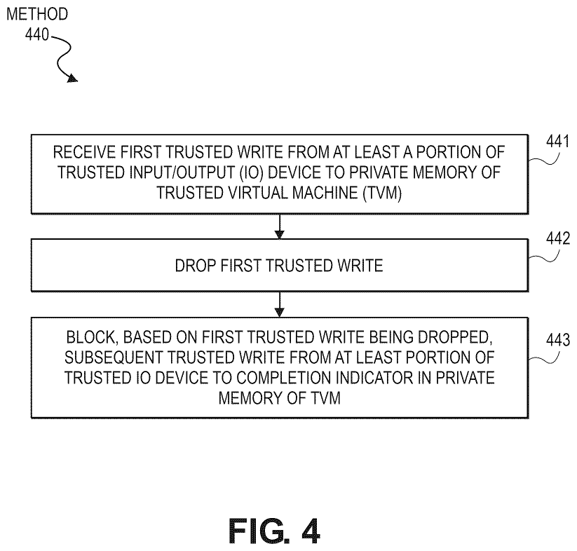

FIG. 4 is a block flow diagram of an embodiment of a method 440. In various embodiments, the method may be performed by a chip (e.g., an SoC). In some embodiments, the method may be performed by and/or within the chip 335 of FIG. 3. The components, features, and specific optional details described herein for the chip 335, also optionally apply to the method 440. Alternatively, the method 440 may be performed by and/or within a similar or different chip or apparatus. Moreover, the chip 335 may perform methods the same as, similar to, or different than the method 440.

A first trusted write is received (e.g., at a chip, a controller, a PCIe IDE controller, etc.) from at least a portion of a trusted IO device to private memory of a TVM, at block 441. In some embodiments, the first trusted write may be a trusted posted write. In some embodiments, the portion 306 of the trusted IO device may be a TDI.

The first trusted write is dropped, at block 442. This may be due to a fault or exceptional condition due to a faulty translation or due to other reasons (e.g., hardware failure, inability of an IO processor to accept another write, etc.).

The method includes blocking, based on the first trusted write being dropped, a second, subsequent trusted write from said at least the portion of the trusted IO device to a completion indicator in the private memory of the TVM, at block 443. The blocking of the second, subsequent trusted write may be done in the various different ways described above for FIG. 3 (e.g., selectively blocking only the second, subsequent trusted write, blocking all trusted writes from the same portion of the trusted IO device, blocking all trusted writes from an IDE selective stream that the first trusted write was sent over, etc.).

The blocking of the second, subsequent trusted write to the completion indicator may prevent the completion indicator from being updated or changed, which in turn may prevent the TVM from accessing incorrect data resulting from the silent drop of the first trusted write, as previously described. In some embodiments, the TVM may optionally timeout and thereafter take one or more corrective actions.

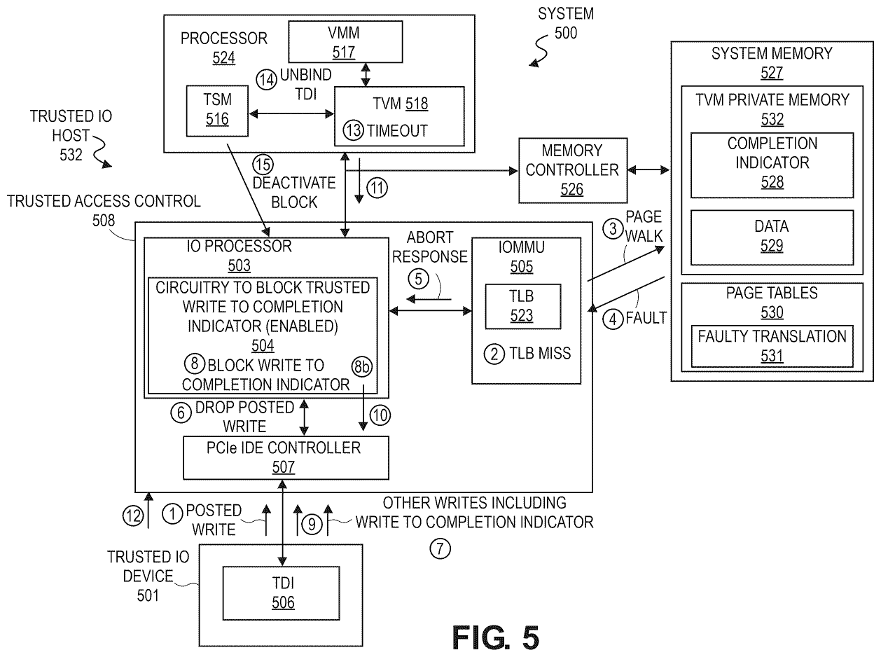

FIG. 5 is a block diagram of an embodiment of a system 500 including a trusted IO host 532 coupled with a trusted IO device 501. The trusted IO host and the trusted IO device may perform trusted IO. In some embodiments, the trusted IO may be according to Intel® TDX Connect. In other embodiments, the trusted IO may be according to AMD's SEV-TIO. In still other embodiments, the trusted IO may be performed according to ARM RME-DA.

The trusted IO host 532 includes a processor 524 to support and execute instructions of a TVM 518 and a VMM 517. The processor may have or offer a trusted execution environment (TEE) to support the TVM. Examples of suitable TVMs include, but are not limited to, trust domains, SEV-SNP virtual machines, and realms. Also shown is a TSM 516. In some cases, the TSM may be implemented in software executed on the processor. In other embodiments, the TSM may be executed by a dedicated processor (e.g., a core serving as a controller). Examples of suitable TSMs include, but are not limited to, TDX modules, ASPs, and RMMs.

The trusted IO host also includes trusted IO access control 508 coupled with the processor. The trusted IO access control includes a PCIe IDE controller 507, an IO processor 503 coupled with the PCIe IDE controller, and an IOMMU 505 coupled with the IO processor. The IO processor includes circuitry 504 to block a trusted write to a completion indicator. In the illustrated embodiment of FIG. 5 the circuitry 504 is in an enabled or turned-on state where it will block the trusted write to the completion indicator. The IOMMU includes a TLB 523.

The trusted IO device 501 is coupled with the PCIe IDE controller 507. As previously shown in FIG. 1, the trusted IO device may also include its own PCIe IDE controller (not shown) to couple with the PCIe IDE controller 507. The trusted IO device includes a TDI 506. Additional or many other TDIs (not shown) may also optionally be included. The trusted IO device may represent any of a wide variety of different types of IO devices, such as, for example, graphics processing units (GPUs), machine-learning processors, artificial intelligence (AI) processors, matrix processors, accelerators, field-programmable gate arrays (FPGAs), application specific integrated circuits (ASICs), and other IO devices known in the arts.

The trusted IO host also includes a memory controller 526 and a system memory 527 coupled with the memory controller. The memory controller is coupled with the processor 524 and coupled with the trusted IO access control 508 to allow the processor, the trusted IO access control, and the trusted IO device to access the system memory. The system memory includes TVM private memory 532 that is private to the TVM 518. The TVM, the TDI 506 (once accepted by the TVM), and other entities trusted by the TVM may be able to access the TVM private memory. However, a VMM (not shown) and other entities not trusted by the TVM may not be able to access the TVM private memory.

The TVM private memory includes data 529. The data 529 may be shared by the trusted IO host and the trusted IO device. For example, the data 529 may include data written into the private memory of the TVM by the trusted IO device. By way of example, the TVM may offload, submit, or otherwise send work or other processing to the trusted IO device (e.g., to the TDI 506). The TVM may specify a location of the data 529 (e.g., a DMA buffer) in the TVM private memory. The trusted IO device may perform the work and then store the data 529 to the memory. The TVM private memory also includes a completion indicator 528 (e.g., a semaphore, a flag, a value used for synchronization between the TVM and the trusted IO device, etc.). By way of example, the trusted IO device may write to, update, or change the completion indicator to indicate that the work or other processing it was assigned has been completed and/or to indicate that the data 529 is available in the TVM private memory for the TVM to access it. The TVM may wait for the completion indicator to be written to, updated, or changed before accessing the data 529. The TVM may implement a timeout mechanism that may cause a timeout if the completion indicator isn't written in a predetermined, threshold, or certain amount of time.

The system memory also includes page tables 530. The page tables contain translations of virtual addresses to host physical addresses that address locations in the system memory 527. The TLB 523 may cache or store some translations of device virtual addresses used by the trusted IO device to host physical addresses. When the trusted IO device needs such translations, it may first check the TLB 523 to see if the needed translations are stored therein. If not, then the IOMMU 505 may perform page table walks to obtain the needed translations from the page tables.

FIG. 5 illustrates how the potential problem described for FIG. 2 may be avoided when the circuitry 504 is enabled and is used to block a trusted write to the completion indicator following the drop of a trusted posted write. Initially, the TVM (e.g., a device driver thereof) may submit work or other processing to at least a portion of the trusted IO device. In this example, the portion is the TDI 506.

As shown at an encircled one (1), as part of performing the work or processing, the TDI may perform a trusted posted write (e.g., a trusted posted DMA write) to the data 529 in the TVM private memory 532. The PCIe IDE controller 507 may receive the trusted posted write and may provide the trusted posted write to the IO processor 503. The IO processor may attempt to obtain an address translation of a device virtual address corresponding to the trusted posted write to a host physical address of the location of the data 529 being written. This may include requesting the needed translation from the IOMMU 505.

As shown at an encircled two (2), the IOMMU may check the TLB 523 to see if the needed translation is stored in the TLB 523 and there may be a TLB miss. Such TLB misses will be encountered some of the time (e.g., if the needed translation has not been used or has not been used recently so it has been evicted from the TLB 523).

As shown at an encircled three (3), the IOMMU 505 may perform a page table walk in the page tables 530 to attempt to obtain the needed translation. Assume for this illustrative example that the needed translation is a faulty translation 531 in the page tables. The faulty translation may be due to a soft error, due to the VMM inadvertently introducing an error, or due to the VMM or another untrusted entity deliberately introducing the error in conjunction with a security attack, as previously described.

As shown at an encircled four (4), a fault may be signaled to the IOMMU 505 (e.g., by the memory controller 526). The fault may represent a page fault, other type of fault, access violation, or other such exceptional condition preventing the needed translation from being returned. As one example, the IOMMU may receive a poison indication from the memory controller due to a TVM owner mismatch. Commonly, the IOMMU may log the fault. In the case of legacy non-trusted VMs, the VMM may have the responsibility of appropriately handling the fault or exceptional condition. However, the VMM is not trusted by the TVM and the TVM cannot trust that the VMM will resolve the fault or exceptional condition. An untrusted VMM may fail to act upon the fault or exceptional condition which may cause incorrect data to be read by the TVM.

As shown at an encircled five (5), the IOMMU may send an abort response to the IO processor. The abort response may represent an unsuccessful return, an indication that the needed translation could not be obtained, or the like.

As shown at an encircled six (6), the IO processor may drop the trusted posted write based on the abort response and/or since the needed translation was not returned. The trusted posted write may be dropped “silently” without the TVM knowing that the trusted posted write was dropped. Although the trusted posted write is described as being dropped herein due to the faulty translation and/or the abort response, it is to be appreciated that the trusted posted write may also potentially be dropped due to other reasons, such as, for example, due to a hardware failure, a communication error, an inability of the IO processor to accept another write, etc. Also, although the trusted posted write is described herein as being dropped it is to be appreciated that other writes or other transactions may also be silently dropped. The approaches disclosed herein may also be applied to drops in these other scenarios.

As shown at an encircled seven (7), after dropping the posted write, the trusted IO device may perform other writes to the data 529 and ultimately (e.g., when the workload has been completed) may perform a trusted write to update or change the completion indicator 528 to indicate that the data 529 is available in the TVM private memory and is ready for the TVM to access it. The IO processor may receive the trusted write to update or change the completion indicator from the PCIe IDE controller.

As shown at an encircled eight (8), the IO processor may block the trusted write to the completion indicator. The IO processor includes the circuitry 504 to block the trusted write to the completion indicator in response to and/or based on and/or after receiving the abort response from the IOMMU. In some embodiments, the circuitry 504 may include filter circuitry, transaction masking circuitry, or the like. Blocking the trusted write to the completion indicator may include preventing it from being sent to the completion indicator such that the completion indicator will not be updated or changed. This blocks the indication from the trusted IO device to the TVM that the data 529 is available and/or that the TVM can/should access the data 529. As a result, the TVM may continue to wait for the write to the completion indicator and may not consume the data 529. This may help to prevent the TVM from reading and using the incorrect data 529 caused by the drop of the trusted write.

The IO processor may block the trusted write to the completion indicator in different ways in different embodiments. In some embodiments, the trusted write to the completion indicator from the TDI 506 (or other same portion of the trusted IO device) may optionally be selectively blocked or prevented without blocking or preventing other trusted writes from the trusted IO device 501. For example, such selectivity may be achieved by blocking based on both a requester identifier (RID) identifying the TDI and an address or memory location of the completion indicator 528. In other embodiments, the IO processor may optionally block or prevent all subsequent trusted writes from the TDI 506 (or other same portion of the trusted IO device) to the private memory of the TVM that occur after the drop of the trusted posted write. For example, all subsequent trusted writes having an RID identifying the TDI may be blocked. In still other embodiments, the IO processor may optionally block or prevent all subsequent trusted writes that are received over an Integrity and Data Encryption (IDE) selective stream over which the trusted posted write that was dropped was previously received. For example, all subsequent trusted writes having a stream identifier (SID) identifying the IDE selective stream may be blocked. In yet embodiments, the IO processor may optionally block or prevent all subsequent trusted writes from the entire trusted IO device 501 to the private memory of the TVM that occur after the drop of the trusted posted write. For example, the IO processor may use mask circuitry or filter circuitry to block trusted writes for all RID in the IO processors RID range. In any of the different embodiments mentioned in this paragraph, the IO processor may optionally also block or prevent all trusted reads to the private memory of the TVM. In any of the different embodiments mentioned in this paragraph, the IO processor may optionally also block or prevent all completions for trusted MMIO reads by the TVM to the TDI (e.g., to a completion indicator within the TDI). In any of the different embodiments mentioned in this paragraph, the IO processor may optionally not block or prevent non-trusted writes (e.g., to locations outside the private memory of the TVM). The present disclosure often describes blocking trusted writes, although the approaches disclosed herein may also be applied in non-trusted legacy virtual machine environments as an approach for handling memory corruption separate from the security aspects trusted virtual machines.

To further illustrate, as shown at an encircled nine (9), the controller may optionally receive a subsequent trusted DMA read to the TVM private memory 532. The subsequent read is subsequent to the posted write that was dropped and may be either before or after the trusted write to the completion indicator. As shown at an encircled ten (10), the IO processor may optionally drop the subsequent trusted DMA read.

To further illustrate, as shown at an encircled eleven (11), the controller may optionally receive a subsequent trusted MMIO read by the TVM to the TDI. For example, the trusted MMIO read may be to a completion indicator of the TDI (e.g., in the TDI's MMIO range). The subsequent trusted MMIO read is subsequent to the posted write that was dropped and may be either before or after the trusted write to the completion indicator. As shown at an encircled twelve (12), the IO processor may optionally block or prevent a completion for the trusted MMIO read. For example, the read completion may be marked as unsuccessful. This may be useful when completions are strictly ordered in relation to the posted writes and when relaxed ordering is disabled.

Often, to limit the impact to the processing performed by the system, it may be desirable where possible to block at a finer granularity rather than at a coarser granularity. For example, in some cases the trusted IO device 501 may have many TDIs and these TDIs may potentially be assigned to many different TVMs. Blocking trusted writes from a single TDI generally will impact only a single TVM and therefore have a relatively low impact. Blocking trusted writes from an IDE selective stream may block trusted writes from several TDIs which may affect multiple TVMs and therefore have a larger impact. Blocking trusted writes from the entire trusted IO device may block trusted writes from all of that devices TDIs which may affect potentially many different TVMs and therefore have an even larger impact. In some cases, it may be observed over time that an increasing number of TDIs need to be blocked. It is unusual that soft errors or accidental errors by a VMM would cause this so this could potentially be indicative that a security attack is underway. In that case, it may be more appropriate to begin blocking at coarser granularity to emphasize security.

Referring again to FIG. 5, as shown at an encircled thirteen (13), the TVM may timeout on waiting for the update or change to the completion indicator. By way of example, the TVM may configure a counter to start counting (e.g., incrementing or decrementing) around the time a workload is initially assigned to the trusted IO device and the timeout may occur when the counter counts for a certain duration (e.g., reaches a certain predetermined or configurable value). The timeout may alert the TVM that the expected change or update to the completion indicator has not occurred in the expected amount of time and/or alert the TVM that something is wrong. In this way, the blocking of the write to the completion indicator may serve to communicate the silent drop of the trusted posted write to the TVM so that the TVM does not use the incorrect data 529 resulting from the silent drop of the first trusted write.

As shown at an encircled fourteen (14), the TVM 518 may initiate unbinding the TDI. The TVM may send a request to the VMM that the VMM unbind the trusted device. The VMM may un-map the MMIO and DMA of the trusted device through the TSM 516. As part of this process, the TSM may invalidate any old address translations in the TLB (not shown) of the processor and the TLB 523 of the IOMMU. The VMM may send a request to the TSM to have the TSM stop the TDI. In this state, the TDI cannot generate trusted transactions. The VMM may request that the TSM performs the unbind operation. The TSM may check that the MMIO and DMA of the trusted device are unmapped from the TVM and that the TDI is in a stopped and in an unlocked state. In some embodiments, an instruction or command may optionally be used to cause the unbinding of the TDI.

As shown at an encircled fifteen (15), the TSM 516 may then deactivate the blocking of trusted writes from the TDI 506. The TSM may check the circuitry 504 to see whether trusted writes from the TDI 506 are currently being blocked. If trusted writes from the TDI 506 are currently being blocked, then the TSM may configure the circuitry 504 to not block trusted writes from the TDI 506. This may be done in different ways depending upon the different ways blocking may be implemented. For example, this may include clearing a requester identifier or stream identifier from the circuitry 504. In some embodiments, an instruction or command may optionally be used to deactivate the blocking of trusted writes.

In some embodiments, the TVM may notify the VMM that there was some issue (e.g., that the trusted write to the completion indicator was never received, that the timeout occurred, etc.). The TVM may also notify the VMM that the problem occurred for a particular portion of the trusted IO device (e.g., the TDI 506). In some cases, there may optionally be a hardware, firmware, or the like, to notify the VMM. For example, the IO processor 503 and/or the circuitry 504 may optionally be operative to notify the VMM (e.g., by setting a flag, setting a bit in a register, sending a transaction, etc.) that blocking has been turned on and optionally about the particular portion (e.g., the TDI 506) of the trusted IO device for which the trusted write was dropped. The VMM may also receive notification in other ways, such as, for example, through the fault or exceptional condition detected by the IOMMU. This may allow the VMM (e.g., in cases where the corruption is not due to a corrupted VMM but rather due to some benign corruption) to take a corrective action or attempt to limit or recover from the problem. In some embodiments, the VMM 517 may perform a method to attempt to recover from the faulty translation 531. For example, one possible corrective action could be to unbind or request that the TSM unbind the TDI or another portion of the trusted IO device from the TVM.

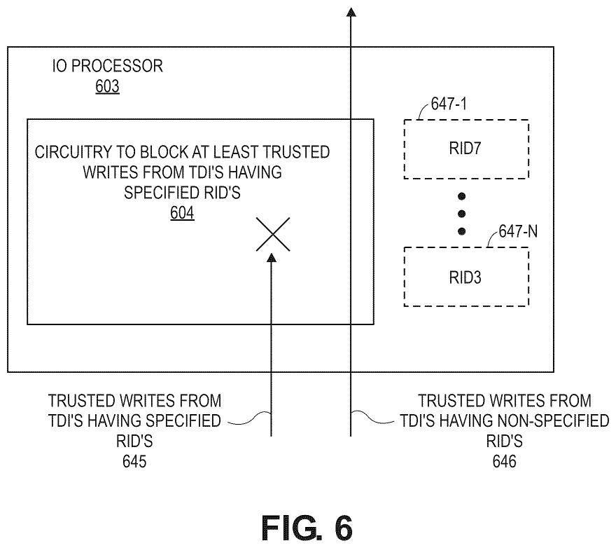

FIG. 6 is a block diagram of a first example embodiment of an IO processor 603 having circuitry 604 to block at least all trusted writes 645 from one or more TDIs that have corresponding requester identifiers (RIDs) that are specified. The circuitry 604 will not block trusted writes 646 from TDIs that have corresponding requester identifiers (RIDs) that are not specified. The IO processor includes a first storage location 647-1 through an Nth storage location 647-N, where N may be any appropriate integer number, such as, for example, 2, 3, 4, 8, 16, 32, 50, 100, 128, etc. Each of the storage locations may be operable to store a corresponding RID. Storing an RID in one of these storage locations may cause the circuitry 604 (e.g., mask circuitry, filter circuitry, etc.) to start filtering, masking, or otherwise blocking trusted writes from the corresponding TDI identified by the RID. In the illustrated example, RID7 is stored in the first storage 647-1 and RID3 is stored in the Nth storage 647-N. If RID7 identifies a TDI7 and RID3 identifies a TDI3, then this may cause the circuitry 604 to block all trusted writes from both TDI7 and TDI3. In some embodiments, when RIDs are stored in all the N storage locations, such that there is no available storage location to store an additional RID that needs to be blocked, then the circuitry may being to block all trusted writes from all RIDs whether or not they are specified in the storage locations. RIDs may also be cleared from the storage locations when blocking no longer needs to be performed for the corresponding TDIs. This may free the storage locations so they may be used to store other RIDs. In some embodiments, the circuitry 604 may also optionally block all trusted reads (e.g., trusted DMA reads) from TDIs that have corresponding RIDs that are specified. In some embodiments, the circuitry 604 may also optionally block all completions for trusted MMIO reads (e.g., by a TVM) to TDIs (e.g., completion indicators of the TDIs) that have corresponding RIDs that are specified. In some embodiments, the circuitry 604 may optionally not block non-trusted writes (e.g., to locations outside the private memory of the TVM) from TDIs that have corresponding RIDs that are specified.

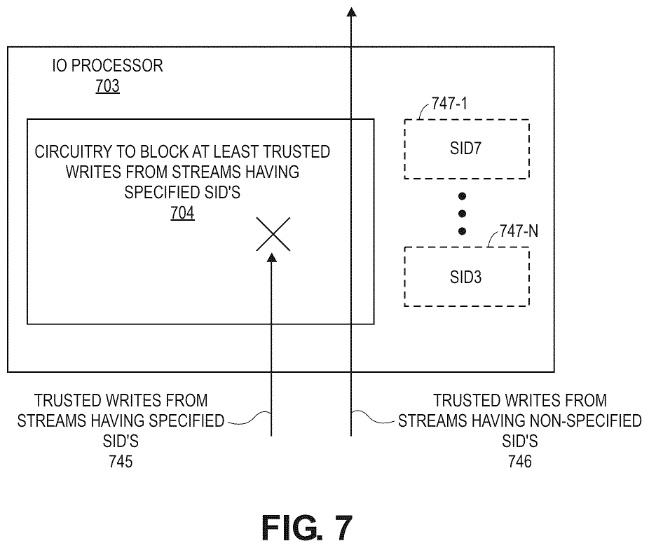

FIG. 7 is a block diagram of a second example embodiment of an IO processor 703 having circuitry 704 to block at least all trusted writes 745 from one or more streams (e.g., IDE selective streams) that have corresponding stream identifiers (SIDs) that are specified. The circuitry 704 will not block trusted writes 746 from streams that have corresponding SIDs that are not specified. The IO processor includes a first storage location 747-1 through an Nth storage location 747-N, where N may be any appropriate integer number, such as, for example, 2, 3, 4, 8, 16, 32, 50, 100, 128, etc. IDE Stream ID is 8 bits, So possible values for IDE Stream IDs are 0 to 255 which includes the ones you have mentioned] Each of the storage locations may be operable to store a corresponding SID. Storing an SID in one of these storage locations may cause the circuitry 704 (e.g., mask circuitry, filter circuitry, etc.) to start filtering, masking, or otherwise blocking trusted writes from the identified stream. In the illustrated example, SID7 is stored in the first storage 747-1 and SID3 is stored in the Nth storage 747-N. This may cause the circuitry 704 to block all trusted writes from both a stream identified by SID7 and a stream identified by SID3. In some embodiments, when SIDs are stored in all the N storage locations, such that there is no available storage location to store an additional SID that needs to be blocked, then the circuitry may being to block all trusted writes from all SIDs whether or not they are specified in the storage locations. SIDs may also be cleared from the storage locations when blocking no longer needs to be performed for the corresponding streams. This may free the storage locations so they may be used to store other SIDs. In some embodiments, the circuitry 704 may also optionally block all trusted reads from streams that have corresponding SIDs that are specified. In some embodiments, the circuitry 704 may also optionally block all completions for trusted MMIO reads (e.g., by a TVM) to TDIs (e.g., completion indicators of the TDIs) of streams that have corresponding SIDs that are specified. In some embodiments, the circuitry 704 may optionally not block non-trusted writes (e.g., to locations outside the private memory of the TVM) from streams that have corresponding SIDs that are specified.

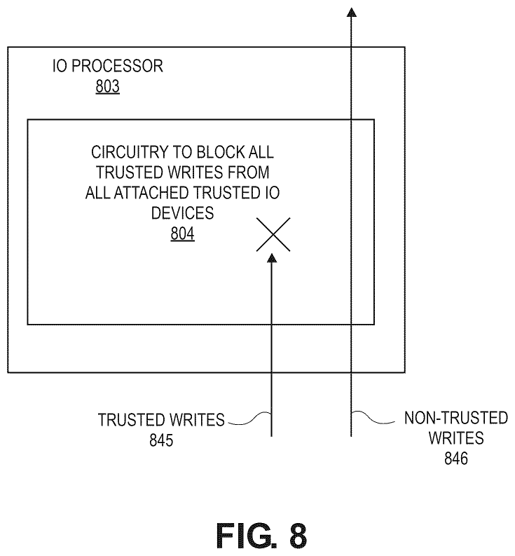

FIG. 8 is a block diagram of a third example embodiment of an IO processor 803 having circuitry 804 (e.g., mask circuitry, filter circuitry, etc.) to mask, filter, or otherwise block at least all trusted writes 845 from all trusted IO devices attached to the IO processor. The circuitry 804 may not block non-trusted writes 846 from the attached trusted IO devices. In some embodiments, the circuitry 804 may also optionally block all trusted reads from the attached trusted IO devices. In some embodiments, the circuitry 804 may also optionally block all completions for trusted MMIO reads (e.g., by a TVM) to the attached trusted IO devices (e.g., to completion indicators of the attached trusted IO devices).

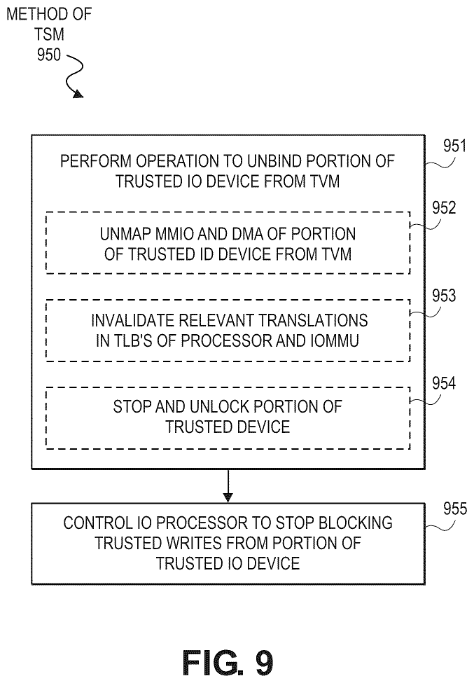

FIG. 9 is a block flow diagram of an embodiment of a method 950 that may be performed by a TSM to unbind a portion of trusted IO device (e.g., a TDI) and cause an IO processor to stop blocking trusted writes from the portion of the trusted IO device. In some embodiments, this may be performed based on a request form a TVM (e.g., after a timeout of the TVM) and based on requests or interactions with a VMM.

At block 951, operations may be performed to unbind the portion of the trusted IO device from the TVM. In some cases, the TSM may do this based on a request from the VMM. In some embodiments, this may optionally include unmapping MMIO and DMA of the portion of the trusted IO device from the TVM, at block 952. In some cases, the TSM may do this based on requests from the VMM. In some embodiments, this may optionally include invalidating relevant translations in TLBs of the processor and the IOMMU (e.g., the TLB 223 and the TLB 225), at block 953. The relevant translations may include those relating to host physical addresses shared by the TVM and the portion of the trusted IO device (e.g., including those of the data 529 and those of the completion indicator 528). In some embodiments, this may optionally include stopping and unlocking the portion of the trusted IO device, at block 954. In some cases, the TSM may do this based on a request from the VMM. Once stopped and unlocked (e.g., in a CONFIG_UNLOCK state), the portion of the trusted IO device may not be able to generate trusted transactions.

At block 955, the TSM may control the IO processor to stop blocking trusted writes from the portion of the trusted IO device. This may be done in different ways in different embodiments (e.g., for the different types of blocking described elsewhere herein). As one example, the TSM may send a RID corresponding to the portion of the trusted IO device (e.g., a TDI) for which blocking is to be stopped. As one example, the TSM may send an SID corresponding to an IDE selective stream for which blocking is to be stopped. In some embodiments, the operation of block 955 may optionally be done following a determination that the IO processor is blocking trusted writes from the portion of the trusted IO device.

### Example Computer Architectures.

Detailed below are descriptions of example computer architectures. Other system designs and configurations known in the arts for laptop, desktop, and handheld personal computers (PC) s, personal digital assistants, engineering workstations, servers, disaggregated servers, network devices, network hubs, switches, routers, embedded processors, digital signal processors (DSPs), graphics devices, video game devices, set-top boxes, micro controllers, cell phones, portable media players, hand-held devices, and various other electronic devices, are also suitable. In general, a variety of systems or electronic devices capable of incorporating a processor and/or other execution logic as disclosed herein are suitable.

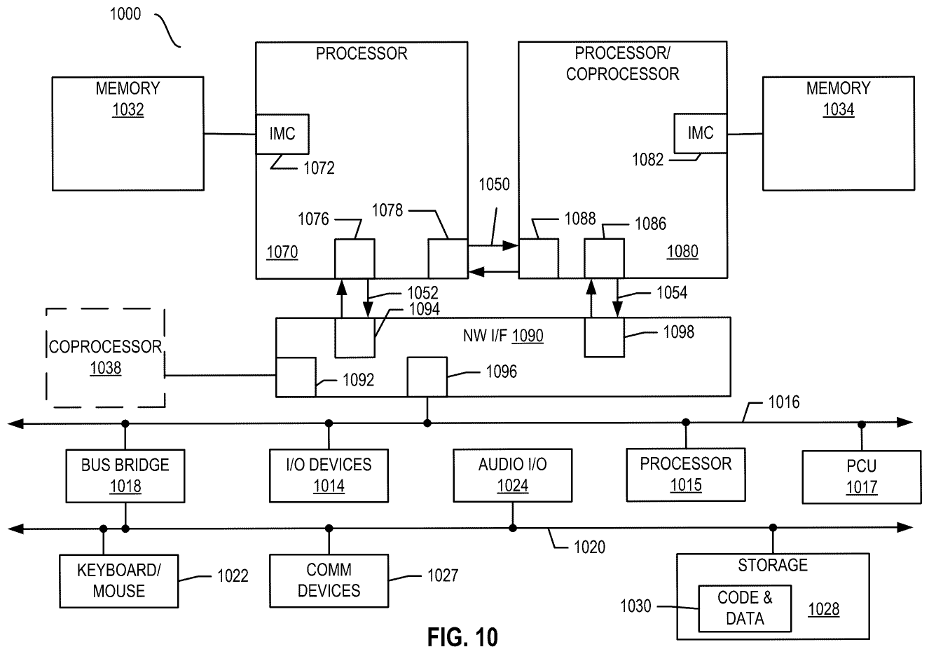

FIG. 10 illustrates an example computing system. Multiprocessor system 1000 is an interfaced system and includes a plurality of processors or cores including a first processor 1070 and a second processor 1080 coupled via an interface 1050 such as a point-to-point (P-P) interconnect, a fabric, and/or bus. In some examples, the first processor 1070 and the second processor 1080 are homogeneous. In some examples, the first processor 1070 and the second processor 1080 are heterogenous. Though the example system 1000 is shown to have two processors, the system may have three or more processors, or may be a single processor system. In some examples, the computing system is a system on a chip (SoC).

Processors 1070 and 1080 are shown including integrated memory controller (IMC) circuitry 1072 and 1082, respectively. Processor 1070 also includes interface circuits 1076 and 1078; similarly, second processor 1080 includes interface circuits 1086 and 1088. Processors 1070, 1080 may exchange information via the interface 1050 using interface circuits 1078, 1088. IMCs 1072 and 1082 couple the processors 1070, 1080 to respective memories, namely a memory 1032 and a memory 1034, which may be portions of main memory locally attached to the respective processors.

Processors 1070, 1080 may each exchange information with a network interface (NW I/F) 1090 via individual interfaces 1052, 1054 using interface circuits 1076, 1094, 1086, 1098. The network interface 1090 (e.g., one or more of an interconnect, bus, and/or fabric, and in some examples is a chipset) may optionally exchange information with a coprocessor 1038 via an interface circuit 1092. In some examples, the coprocessor 1038 is a special-purpose processor, such as, for example, a high-throughput processor, a network or communication processor, compression engine, graphics processor, general purpose graphics processing unit (GPGPU), neural-network processing unit (NPU), embedded processor, or the like.

A shared cache (not shown) may be included in either processor 1070, 1080 or outside of both processors, yet connected with the processors via an interface such as P-P interconnect, such that either or both processors' local cache information may be stored in the shared cache if a processor is placed into a low power mode.

Network interface 1090 may be coupled to a first interface 1016 via interface circuit 1096. In some examples, the first interface 1016 may be an interface such as a Peripheral Component Interconnect (PCI) interconnect, a PCI Express interconnect or another I/O interconnect. In some examples, the first interface 1016 is coupled to a power control unit (PCU) 1017, which may include circuitry, software, and/or firmware to perform power management operations regarding the processors 1070, 1080 and/or co-processor 1038. PCU 1017 provides control information to a voltage regulator (not shown) to cause the voltage regulator to generate the appropriate regulated voltage. PCU 1017 also provides control information to control the operating voltage generated. In various examples, PCU 1017 may include a variety of power management logic units (circuitry) to perform hardware-based power management. Such power management may be wholly processor controlled (e.g., by various processor hardware, and which may be triggered by workload and/or power, thermal or other processor constraints) and/or the power management may be performed responsive to external sources (such as a platform or power management source or system software).

PCU 1017 is illustrated as being present as logic separate from the processor 1070 and/or processor 1080. In other cases, PCU 1017 may execute on a given one or more of cores (not shown) of processor 1070 or 1080. In some cases, PCU 1017 may be implemented as a microcontroller (dedicated or general-purpose) or other control logic configured to execute its own dedicated power management code, sometimes referred to as P-code. In yet other examples, power management operations to be performed by PCU 1017 may be implemented externally to a processor, such as by way of a separate power management integrated circuit (PMIC) or another component external to the processor. In yet other examples, power management operations to be performed by PCU 1017 may be implemented within BIOS or other system software.

Various I/O devices 1014 may be coupled to first interface 1016, along with a bus bridge 1018 which couples first interface 1016 to a second interface 1020. In some examples, one or more additional processor(s) 1015, such as coprocessors, high throughput many integrated core (MIC) processors, GPGPUs, accelerators (such as graphics accelerators or digital signal processing (DSP) units), field programmable gate arrays (FPGAs), or any other processor, are coupled to first interface 1016. In some examples, the second interface 1020 may be a low pin count (LPC) interface. Various devices may be coupled to second interface 1020 including, for example, a keyboard and/or mouse 1022, communication devices 1027 and storage circuitry 1028. Storage circuitry 1028 may be one or more non-transitory machine-readable storage media as described below, such as a disk drive or other mass storage device which may include instructions/code and data 1030 and may implement the storage ‘ISAB03 in some examples. Further, an audio I/O 1024 may be coupled to second interface 1020. Note that other architectures than the point-to-point architecture described above are possible. For example, instead of the point-to-point architecture, a system such as multiprocessor system 1000 may implement a multi-drop interface or other such architecture.

### Example Core Architectures, Processors, and Computer Architectures.

Processor cores may be implemented in different ways, for different purposes, and in different processors. For instance, implementations of such cores may include: 1) a general purpose in-order core intended for general-purpose computing; 2) a high-performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput) computing. Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip (SoC) that may be included on the same die as the described CPU (sometimes referred to as the application core(s) or application processor(s)), the above described coprocessor, and additional functionality. Example core architectures are described next, followed by descriptions of example processors and computer architectures.

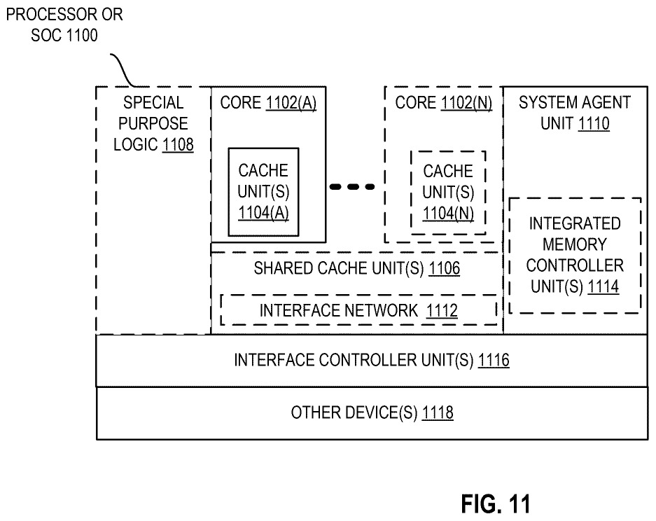

FIG. 11 illustrates a block diagram of an example processor and/or SoC 1100 that may have one or more cores and an integrated memory controller. The solid lined boxes illustrate a processor 1100 with a single core 1102(A), system agent unit circuitry 1110, and a set of one or more interface controller unit(s) circuitry 1116, while the optional addition of the dashed lined boxes illustrates an alternative processor 1100 with multiple cores 1102(A)-(N), a set of one or more integrated memory controller unit(s) circuitry 1114 in the system agent unit circuitry 1110, and special purpose logic 1108, as well as a set of one or more interface controller units circuitry 1116. Note that the processor 1100 may be one of the processors 1070 or 1080, or co-processor 1038 or 1015 of FIG. 10.

Thus, different implementations of the processor 1100 may include: 1) a CPU with the special purpose logic 1108 being integrated graphics and/or scientific (throughput) logic (which may include one or more cores, not shown), and the cores 1102(A)-(N) being one or more general purpose cores (e.g., general purpose in-order cores, general purpose out-of-order cores, or a combination of the two); 2) a coprocessor with the cores 1102(A)-(N) being a large number of special purpose cores intended primarily for graphics and/or scientific (throughput); and 3) a coprocessor with the cores 1102(A)-(N) being a large number of general purpose in-order cores. Thus, the processor 1100 may be a general-purpose processor, coprocessor or special-purpose processor, such as, for example, a network or communication processor, compression engine, graphics processor, GPGPU (general purpose graphics processing unit), a high throughput many integrated core (MIC) coprocessor (including 30 or more cores), embedded processor, or the like. The processor may be implemented on one or more chips. The processor 1100 may be a part of and/or may be implemented on one or more substrates using any of several process technologies, such as, for example, complementary metal oxide semiconductor (CMOS), bipolar CMOS (BiCMOS), P-type metal oxide semiconductor (PMOS), or N-type metal oxide semiconductor (NMOS).

A memory hierarchy includes one or more levels of cache unit(s) circuitry 1104(A)-(N) within the cores 1102(A)-(N), a set of one or more shared cache unit(s) circuitry 1106, and external memory (not shown) coupled to the set of integrated memory controller unit(s) circuitry 1114. The set of one or more shared cache unit(s) circuitry 1106 may include one or more mid-level caches, such as level 2 (L2), level 3 (L3), level 4 (L4), or other levels of cache, such as a last level cache (LLC), and/or combinations thereof. While in some examples interface network circuitry 1112 (e.g., a ring interconnect) interfaces the special purpose logic 1108 (e.g., integrated graphics logic), the set of shared cache unit(s) circuitry 1106, and the system agent unit circuitry 1110, alternative examples use any number of well-known techniques for interfacing such units. In some examples, coherency is maintained between one or more of the shared cache unit(s) circuitry 1106 and cores 1102(A)-(N). In some examples, interface controller units circuitry 1116 couple the cores 1102 to one or more other devices 1118 such as one or more I/O devices, storage, one or more communication devices (e.g., wireless networking, wired networking, etc.), etc.

In some examples, one or more of the cores 1102(A)-(N) are capable of multi-threading. The system agent unit circuitry 1110 includes those components coordinating and operating cores 1102(A)-(N). The system agent unit circuitry 1110 may include, for example, power control unit (PCU) circuitry and/or display unit circuitry (not shown). The PCU may be or may include logic and components needed for regulating the power state of the cores 1102(A)-(N) and/or the special purpose logic 1108 (e.g., integrated graphics logic). The display unit circuitry is for driving one or more externally connected displays.

The cores 1102(A)-(N) may be homogenous in terms of instruction set architecture (ISA). Alternatively, the cores 1102(A)-(N) may be heterogeneous in terms of ISA; that is, a subset of the cores 1102(A)-(N) may be capable of executing an ISA, while other cores may be capable of executing only a subset of that ISA or another ISA.

### Example Core Architectures—In-Order and Out-of-Order Core Block Diagram.

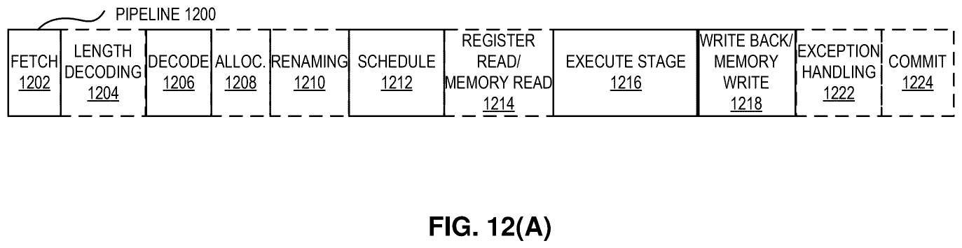

FIG. 12(A) is a block diagram illustrating both an example in-order pipeline and an example register renaming, out-of-order issue/execution pipeline according to examples. FIG. 12(B) is a block diagram illustrating both an example in-order architecture core and an example register renaming, out-of-order issue/execution architecture core to be included in a processor according to examples. The solid lined boxes in FIGS. 12(A)-(B) illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 12(A), a processor pipeline 1200 includes a fetch stage 1202, an optional length decoding stage 1204, a decode stage 1206, an optional allocation (Alloc) stage 1208, an optional renaming stage 1210, a schedule (also known as a dispatch or issue) stage 1212, an optional register read/memory read stage 1214, an execute stage 1216, a write back/memory write stage 1218, an optional exception handling stage 1222, and an optional commit stage 1224. One or more operations can be performed in each of these processor pipeline stages. For example, during the fetch stage 1202, one or more instructions are fetched from instruction memory, and during the decode stage 1206, the one or more fetched instructions may be decoded, addresses (e.g., load store unit (LSU) addresses) using forwarded register ports may be generated, and branch forwarding (e.g., immediate offset or a link register (LR)) may be performed. In one example, the decode stage 1206 and the register read/memory read stage 1214 may be combined into one pipeline stage. In one example, during the execute stage 1216, the decoded instructions may be executed, LSU address/data pipelining to an Advanced Microcontroller Bus (AMB) interface may be performed, multiply and add operations may be performed, arithmetic operations with branch results may be performed, etc.

By way of example, the example register renaming, out-of-order issue/execution architecture core of FIG. 12(B) may implement the pipeline 1200 as follows: 1) the instruction fetch circuitry 1238 performs the fetch and length decoding stages 1202 and 1204; 2) the decode circuitry 1240 performs the decode stage 1206; 3) the rename/allocator unit circuitry 1252 performs the allocation stage 1208 and renaming stage 1210; 4) the scheduler(s) circuitry 1256 performs the schedule stage 1212; 5) the physical register file(s) circuitry 1258 and the memory unit circuitry 1270 perform the register read/memory read stage 1214; the execution cluster(s) 1260 perform the execute stage 1216; 6) the memory unit circuitry 1270 and the physical register file(s) circuitry 1258 perform the write back/memory write stage 1218; 7) various circuitry may be involved in the exception handling stage 1222; and 8) the retirement unit circuitry 1254 and the physical register file(s) circuitry 1258 perform the commit stage 1224.

FIG. 12(B) shows a processor core 1290 including front-end unit circuitry 1230 coupled to execution engine unit circuitry 1250, and both are coupled to memory unit circuitry 1270. The core 1290 may be a reduced instruction set architecture computing (RISC) core, a complex instruction set architecture computing (CISC) core, a very long instruction word (VLIW) core, or a hybrid or alternative core type. As yet another option, the core 1290 may be a special-purpose core, such as, for example, a network or communication core, compression engine, coprocessor core, general purpose computing graphics processing unit (GPGPU) core, graphics core, or the like.

The front-end unit circuitry 1230 may include branch prediction circuitry 1232 coupled to instruction cache circuitry 1234, which is coupled to an instruction translation lookaside buffer (TLB) 1236, which is coupled to instruction fetch circuitry 1238, which is coupled to decode circuitry 1240. In one example, the instruction cache circuitry 1234 is included in the memory unit circuitry 1270 rather than the front-end circuitry 1230. The decode circuitry 1240 (or decoder) may decode instructions, and generate as an output one or more micro-operations, microcode entry points, microinstructions, other instructions, or other control signals, which are decoded from, or which otherwise reflect, or are derived from, the original instructions. The decode circuitry 1240 may further include address generation unit (AGU, not shown) circuitry. In one example, the AGU generates an LSU address using forwarded register ports, and may further perform branch forwarding (e.g., immediate offset branch forwarding, LR register branch forwarding, etc.). The decode circuitry 1240 may be implemented using various mechanisms. Examples of suitable mechanisms include, but are not limited to, look-up tables, hardware implementations, programmable logic arrays (PLAs), microcode read only memories (ROMs), etc. In one example, the core 1290 includes a microcode ROM (not shown) or other medium that stores microcode for certain macroinstructions (e.g., in decode circuitry 1240 or otherwise within the front-end circuitry 1230). In one example, the decode circuitry 1240 includes a micro-operation (micro-op) or operation cache (not shown) to hold/cache decoded operations, micro-tags, or micro-operations generated during the decode or other stages of the processor pipeline 1200. The decode circuitry 1240 may be coupled to rename/allocator unit circuitry 1252 in the execution engine circuitry 1250.

The execution engine circuitry 1250 includes the rename/allocator unit circuitry 1252 coupled to retirement unit circuitry 1254 and a set of one or more scheduler(s) circuitry 1256. The scheduler(s) circuitry 1256 represents any number of different schedulers, including reservations stations, central instruction window, etc. In some examples, the scheduler(s) circuitry 1256 can include arithmetic logic unit (ALU) scheduler/scheduling circuitry, ALU queues, address generation unit (AGU) scheduler/scheduling circuitry, AGU queues, etc. The scheduler(s) circuitry 1256 is coupled to the physical register file(s) circuitry 1258. Each of the physical register file(s) circuitry 1258 represents one or more physical register files, different ones of which store one or more different data types, such as scalar integer, scalar floating-point, packed integer, packed floating-point, vector integer, vector floating-point, status (e.g., an instruction pointer that is the address of the next instruction to be executed), etc. In one example, the physical register file(s) circuitry 1258 includes vector registers unit circuitry, writemask registers unit circuitry, and scalar register unit circuitry. These register units may provide architectural vector registers, vector mask registers, general-purpose registers, etc. The physical register file(s) circuitry 1258 is coupled to the retirement unit circuitry 1254 (also known as a retire queue or a retirement queue) to illustrate various ways in which register renaming and out-of-order execution may be implemented (e.g., using a reorder buffer(s) (ROB(s)) and a retirement register file(s); using a future file(s), a history buffer(s), and a retirement register file(s); using a register maps and a pool of registers; etc.). The retirement unit circuitry 1254 and the physical register file(s) circuitry 1258 are coupled to the execution cluster(s) 1260. The execution cluster(s) 1260 includes a set of one or more execution unit(s) circuitry 1262 and a set of one or more memory access circuitry 1264. The execution unit(s) circuitry 1262 may perform various arithmetic, logic, floating-point or other types of operations (e.g., shifts, addition, subtraction, multiplication) and on various types of data (e.g., scalar integer, scalar floating-point, packed integer, packed floating-point, vector integer, vector floating-point). While some examples may include several execution units or execution unit circuitry dedicated to specific functions or sets of functions, other examples may include only one execution unit circuitry or multiple execution units/execution unit circuitry that all perform all functions. The scheduler(s) circuitry 1256, physical register file(s) circuitry 1258, and execution cluster(s) 1260 are shown as being possibly plural because certain examples create separate pipelines for certain types of data/operations (e.g., a scalar integer pipeline, a scalar floating-point/packed integer/packed floating-point/vector integer/vector floating-point pipeline, and/or a memory access pipeline that each have their own scheduler circuitry, physical register file(s) circuitry, and/or execution cluster- and in the case of a separate memory access pipeline, certain examples are implemented in which only the execution cluster of this pipeline has the memory access unit(s) circuitry 1264). It should also be understood that where separate pipelines are used, one or more of these pipelines may be out-of-order issue/execution and the rest in-order.

In some examples, the execution engine unit circuitry 1250 may perform load store unit (LSU) address/data pipelining to an Advanced Microcontroller Bus (AMB) interface (not shown), and address phase and writeback, data phase load, store, and branches.

The set of memory access circuitry 1264 is coupled to the memory unit circuitry 1270, which includes data TLB circuitry 1272 coupled to data cache circuitry 1274 coupled to level 2 (L2) cache circuitry 1276. In one example, the memory access circuitry 1264 may include load unit circuitry, store address unit circuitry, and store data unit circuitry, each of which is coupled to the data TLB circuitry 1272 in the memory unit circuitry 1270. The instruction cache circuitry 1234 is further coupled to the level 2 (L2) cache circuitry 1276 in the memory unit circuitry 1270. In one example, the instruction cache 1234 and the data cache 1274 are combined into a single instruction and data cache (not shown) in L2 cache circuitry 1276, level 3 (L3) cache circuitry (not shown), and/or main memory. The L2 cache circuitry 1276 is coupled to one or more other levels of cache and eventually to a main memory.

The core 1290 may support one or more instructions sets (e.g., the x86 instruction set architecture (optionally with some extensions that have been added with newer versions); the MIPS instruction set architecture; the ARM instruction set architecture (optionally with optional additional extensions such as NEON)), including the instruction(s) described herein. In one example, the core 1290 includes logic to support a packed data instruction set architecture extension (e.g., AVX1, AVX2), thereby allowing the operations used by many multimedia applications to be performed using packed data.

### Example Execution Unit(s) Circuitry.

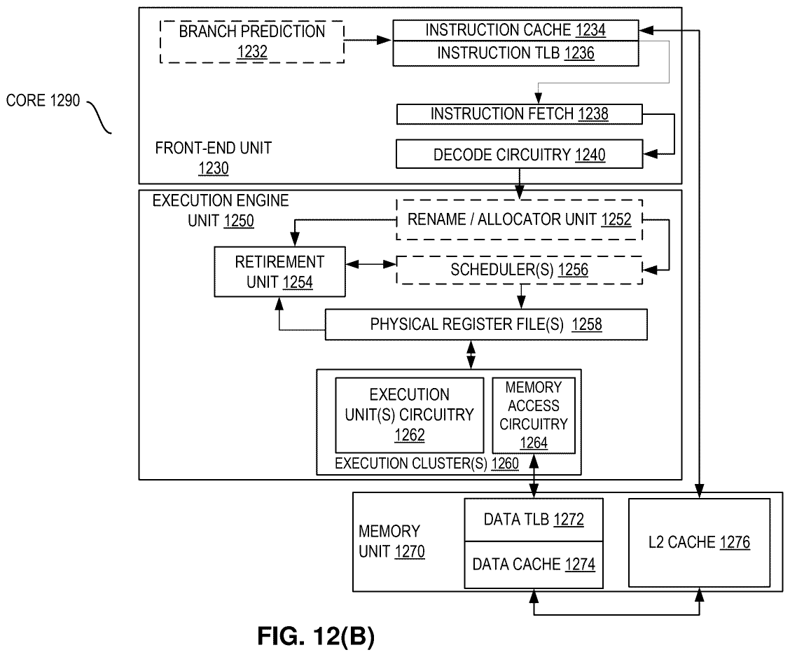

FIG. 13 illustrates examples of execution unit(s) circuitry, such as execution unit(s) circuitry 1262 of FIG. 12(B). As illustrated, execution unit(s) circuitry 1262 may include one or more ALU circuits 1301, optional vector/single instruction multiple data (SIMD) circuits 1303, load/store circuits 1305, branch/jump circuits 1307, and/or Floating-point unit (FPU) circuits 1309. ALU circuits 1301 perform integer arithmetic and/or Boolean operations. Vector/SIMD circuits 1303 perform vector/SIMD operations on packed data (such as SIMD/vector registers). Load/store circuits 1305 execute load and store instructions to load data from memory into registers or store from registers to memory. Load/store circuits 1305 may also generate addresses. Branch/jump circuits 1307 cause a branch or jump to a memory address depending on the instruction. FPU circuits 1309 perform floating-point arithmetic. The width of the execution unit(s) circuitry 1262 varies depending upon the example and can range from 16-bit to 1,024-bit, for example. In some examples, two or more smaller execution units are logically combined to form a larger execution unit (e.g., two 128-bit execution units are logically combined to form a 256-bit execution unit).

### Example Register Architecture.

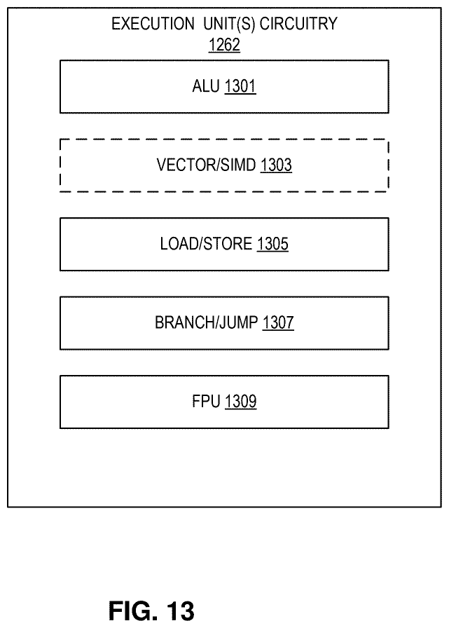

FIG. 14 is a block diagram of a register architecture 1400 according to some examples. As illustrated, the register architecture 1400 includes vector/SIMD registers 1410 that vary from 128-bit to 1,024 bits width. In some examples, the vector/SIMD registers 1410 are physically 512-bits and, depending upon the mapping, only some of the lower bits are used. For example, in some examples, the vector/SIMD registers 1410 are ZMM registers which are 512 bits: the lower 256 bits are used for YMM registers and the lower 128 bits are used for XMM registers. As such, there is an overlay of registers. In some examples, a vector length field selects between a maximum length and one or more other shorter lengths, where each such shorter length is half the length of the preceding length. Scalar operations are operations performed on the lowest order data element position in a ZMM/YMM/XMM register; the higher order data element positions are either left the same as they were prior to the instruction or zeroed depending on the example.

In some examples, the register architecture 1400 includes writemask/predicate registers 1415. For example, in some examples, there are 8 writemask/predicate registers (sometimes called k0 through k7) that are each 16-bit, 32-bit, 64-bit, or 128-bit in size. Writemask/predicate registers 1415 may allow for merging (e.g., allowing any set of elements in the destination to be protected from updates during the execution of any operation) and/or zeroing (e.g., zeroing vector masks allow any set of elements in the destination to be zeroed during the execution of any operation). In some examples, each data element position in a given writemask/predicate register 1415 corresponds to a data element position of the destination. In other examples, the writemask/predicate registers 1415 are scalable and consists of a set number of enable bits for a given vector element (e.g., 8 enable bits per 64-bit vector element).

The register architecture 1400 includes a plurality of general-purpose registers 1425. These registers may be 16-bit, 32-bit, 64-bit, etc. and can be used for scalar operations. In some examples, these registers are referenced by the names RAX, RBX, RCX, RDX, RBP, RSI, RDI, RSP, and R8 through R15.

In some examples, the register architecture 1400 includes scalar floating-point (FP) register file 1445 which is used for scalar floating-point operations on 32/64/80-bit floating-point data using the x87 instruction set architecture extension or as MMX registers to perform operations on 64-bit packed integer data, as well as to hold operands for some operations performed between the MMX and XMM registers.

One or more flag registers 1440 (e.g., EFLAGS, RFLAGS, etc.) store status and control information for arithmetic, compare, and system operations. For example, the one or more flag registers 1440 may store condition code information such as carry, parity, auxiliary carry, zero, sign, and overflow. In some examples, the one or more flag registers 1440 are called program status and control registers.

Segment registers 1420 contain segment points for use in accessing memory. In some examples, these registers are referenced by the names CS, DS, SS, ES, FS, and GS.

Machine specific registers (MSRs) 1435 control and report on processor performance. Most MSRs 1435 handle system-related functions and are not accessible to an application program. Machine check registers 1460 consist of control, status, and error reporting MSRs that are used to detect and report on hardware errors.

One or more instruction pointer register(s) 1430 store an instruction pointer value. Control register(s) 1455 (e.g., CR0-CR4) determine the operating mode of a processor (e.g., processor 1070, 1080, 1038, 1015, and/or 1100) and the characteristics of a currently executing task. Debug registers 1450 control and allow for the monitoring of a processor or core's debugging operations.

Memory (mem) management registers 1465 specify the locations of data structures used in protected mode memory management. These registers may include a global descriptor table register (GDTR), interrupt descriptor table register (IDTR), task register, and a local descriptor table register (LDTR) register.

Alternative examples may use wider or narrower registers. Additionally, alternative examples may use more, less, or different register files and registers. The register architecture 1400 may, for example, be used in register file/memory ‘ISAB08, or physical register file(s) circuitry 1258.

### Instruction Set Architectures.

An instruction set architecture (ISA) may include one or more instruction formats. A given instruction format may define various fields (e.g., number of bits, location of bits) to specify, among other things, the operation to be performed (e.g., opcode) and the operand(s) on which that operation is to be performed and/or other data field(s) (e.g., mask). Some instruction formats are further broken down through the definition of instruction templates (or sub-formats). For example, the instruction templates of a given instruction format may be defined to have different subsets of the instruction format's fields (the included fields are typically in the same order, but at least some have different bit positions because there are less fields included) and/or defined to have a given field interpreted differently. Thus, each instruction of an ISA is expressed using a given instruction format (and, if defined, in a given one of the instruction templates of that instruction format) and includes fields for specifying the operation and the operands. For example, an example ADD instruction has a specific opcode and an instruction format that includes an opcode field to specify that opcode and operand fields to select operands (source1/destination and source2); and an occurrence of this ADD instruction in an instruction stream will have specific contents in the operand fields that select specific operands. In addition, though the description below is made in the context of x86 ISA, it is within the knowledge of one skilled in the art to apply the teachings of the present disclosure in another ISA.

### Example Instruction Formats.

Examples of the instruction(s) described herein may be embodied in different formats. Additionally, example systems, architectures, and pipelines are detailed below. Examples of the instruction(s) may be executed on such systems, architectures, and pipelines, but are not limited to those detailed.

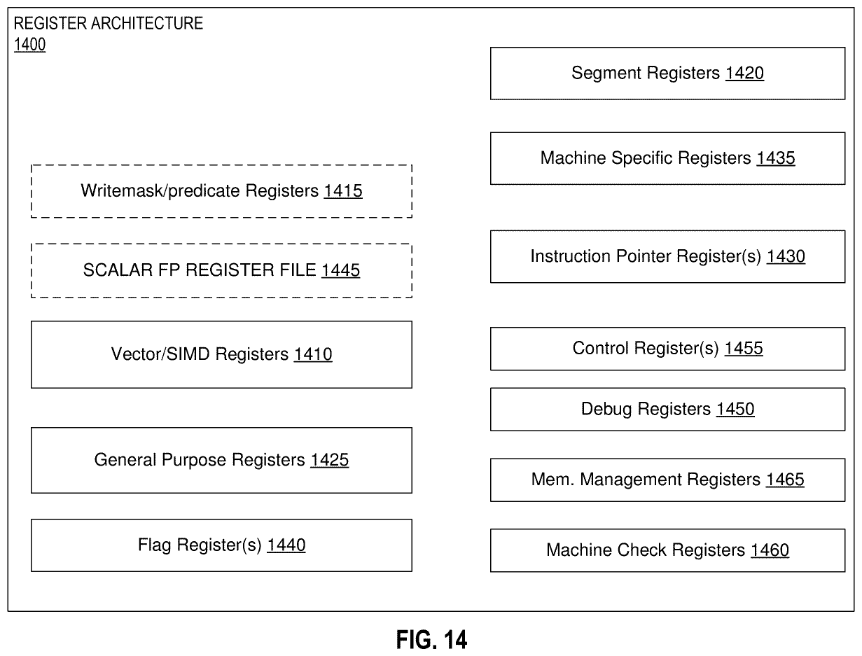

FIG. 15 illustrates examples of an instruction format. As illustrated, an instruction may include multiple components including, but not limited to, one or more fields for: one or more prefixes 1501, an opcode 1503, addressing information 1505 (e.g., register identifiers, memory addressing information, etc.), a displacement value 1507, and/or an immediate value 1509. Note that some instructions utilize some or all the fields of the format whereas others may only use the field for the opcode 1503. In some examples, the order illustrated is the order in which these fields are to be encoded, however, it should be appreciated that in other examples these fields may be encoded in a different order, combined, etc.

The prefix(es) field(s) 1501, when used, modifies an instruction. In some examples, one or more prefixes are used to repeat string instructions (e.g., 0xF0, 0xF2, 0xF3, etc.), to provide section overrides (e.g., 0x2E, 0x36, 0x3E, 0x26, 0x64, 0x65, 0x2E, 0x3E, etc.), to perform bus lock operations, and/or to change operand (e.g., 0x66) and address sizes (e.g., 0x67). Certain instructions require a mandatory prefix (e.g., 0x66, 0xF2, 0xF3, etc.). Certain of these prefixes may be considered “legacy” prefixes. Other prefixes, one or more examples of which are detailed herein, indicate, and/or provide further capability, such as specifying particular registers, etc. The other prefixes typically follow the “legacy” prefixes.

The opcode field 1503 is used to at least partially define the operation to be performed upon a decoding of the instruction. In some examples, a primary opcode encoded in the opcode field 1503 is one, two, or three bytes in length. In other examples, a primary opcode can be a different length. An additional 3-bit opcode field is sometimes encoded in another field.

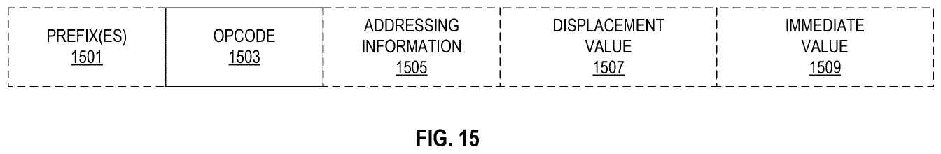

The addressing information field 1505 is used to address one or more operands of the instruction, such as a location in memory or one or more registers. FIG. 16 illustrates examples of the addressing information field 1505. In this illustration, an optional MOD R/M byte 1602 and an optional Scale, Index, Base (SIB) byte 1604 are shown. The MOD R/M byte 1602 and the SIB byte 1604 are used to encode up to two operands of an instruction, each of which is a direct register or effective memory address. Note that both fields are optional in that not all instructions include one or more of these fields. The MOD R/M byte 1602 includes a MOD field 1642, a register (reg) field 1644, and R/M field 1646.

The content of the MOD field 1642 distinguishes between memory access and non-memory access modes. In some examples, when the MOD field 1642 has a binary value of 11 (11b), a register-direct addressing mode is utilized, and otherwise a register-indirect addressing mode is used.

The register field 1644 may encode either the destination register operand or a source register operand or may encode an opcode extension and not be used to encode any instruction operand. The content of register field 1644, directly or through address generation, specifies the locations of a source or destination operand (either in a register or in memory). In some examples, the register field 1644 is supplemented with an additional bit from a prefix (e.g., prefix 1501) to allow for greater addressing.

The R/M field 1646 may be used to encode an instruction operand that references a memory address or may be used to encode either the destination register operand or a source register operand. Note the R/M field 1646 may be combined with the MOD field 1642 to dictate an addressing mode in some examples.

The SIB byte 1604 includes a scale field 1652, an index field 1654, and a base field 1656 to be used in the generation of an address. The scale field 1652 indicates a scaling factor. The index field 1654 specifies an index register to use. In some examples, the index field 1654 is supplemented with an additional bit from a prefix (e.g., prefix 1501) to allow for greater addressing. The base field 1656 specifies a base register to use. In some examples, the base field 1656 is supplemented with an additional bit from a prefix (e.g., prefix 1501) to allow for greater addressing. In practice, the content of the scale field 1652 allows for the scaling of the content of the index field 1654 for memory address generation (e.g., for address generation that uses 2^{scale}*index+base).

Some addressing forms utilize a displacement value to generate a memory address. For example, a memory address may be generated according to 2^{scale}*index+base+displacement, index*scale+displacement, r/m+displacement, instruction pointer (RIP/EIP)+displacement, register+displacement, etc. The displacement may be a 1-byte, 2-byte, 4-byte, etc. value. In some examples, the displacement field 1507 provides this value. Additionally, in some examples, a displacement factor usage is encoded in the MOD field of the addressing information field 1505 that indicates a compressed displacement scheme for which a displacement value is calculated and stored in the displacement field 1507.

In some examples, the immediate value field 1509 specifies an immediate value for the instruction. An immediate value may be encoded as a 1-byte value, a 2-byte value, a 4-byte value, etc.

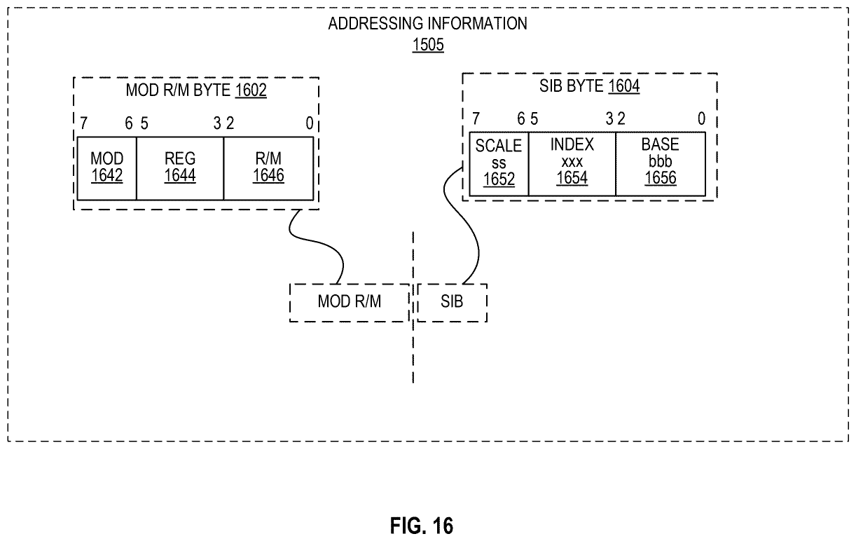

FIG. 17 illustrates examples of a first prefix 1501(A). In some examples, the first prefix 1501(A) is an example of a REX prefix. Instructions that use this prefix may specify general purpose registers, 64-bit packed data registers (e.g., single instruction, multiple data (SIMD) registers or vector registers), and/or control registers and debug registers (e.g., CR8-CR15 and DR8-DR15).

Instructions using the first prefix 1501(A) may specify up to three registers using 3-bit fields depending on the format: 1) using the reg field 1644 and the R/M field 1646 of the MOD R/M byte 1602; 2) using the MOD R/M byte 1602 with the SIB byte 1604 including using the reg field 1644 and the base field 1656 and index field 1654; or 3) using the register field of an opcode.

In the first prefix 1501(A), bit positions 7:4 are set as 0100. Bit position 3 (W) can be used to determine the operand size but may not solely determine operand width. As such, when W=0, the operand size is determined by a code segment descriptor (CS.D) and when W=1, the operand size is 64-bit.

Note that the addition of another bit allows for 16 (2⁴) registers to be addressed, whereas the MOD R/M reg field 1644 and MOD R/M R/M field 1646 alone can each only address 8 registers.

In the first prefix 1501(A), bit position 2 (R) may be an extension of the MOD R/M reg field 1644 and may be used to modify the MOD R/M reg field 1644 when that field encodes a general-purpose register, a 64-bit packed data register (e.g., a SSE register), or a control or debug register. R is ignored when MOD R/M byte 1602 specifies other registers or defines an extended opcode.

Bit position 1 (X) may modify the SIB byte index field 1654.

Bit position 0 (B) may modify the base in the MOD R/M R/M field 1646 or the SIB byte base field 1656; or it may modify the opcode register field used for accessing general purpose registers (e.g., general purpose registers 1425).

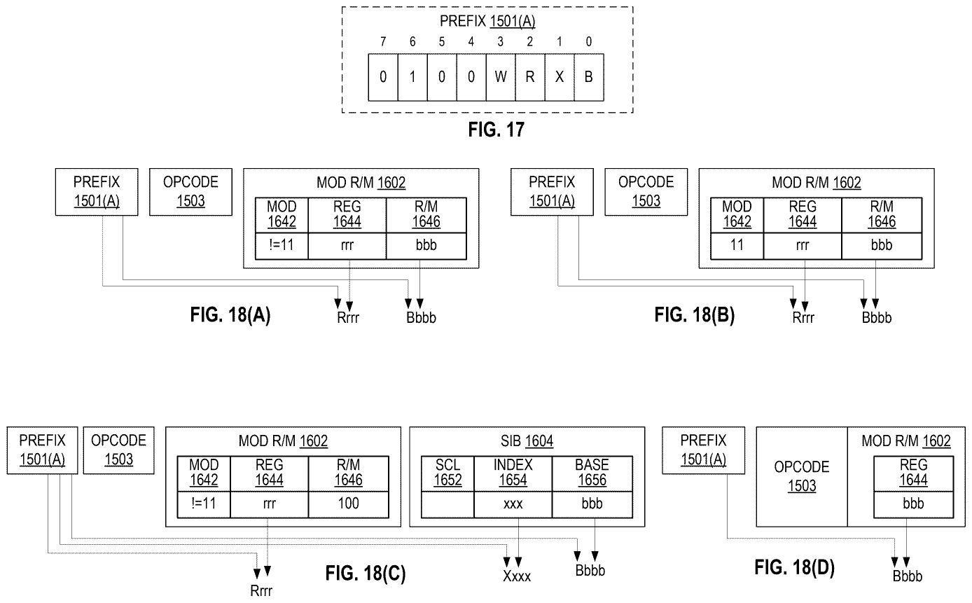

FIGS. 18(A)-(D) illustrate examples of how the R, X, and B fields of the first prefix 1501(A) are used. FIG. 18(A) illustrates R and B from the first prefix 1501(A) being used to extend the reg field 1644 and R/M field 1646 of the MOD R/M byte 1602 when the SIB byte 1604 is not used for memory addressing. FIG. 18(B) illustrates R and B from the first prefix 1501(A) being used to extend the reg field 1644 and R/M field 1646 of the MOD R/M byte 1602 when the SIB byte 1604 is not used (register-register addressing). FIG. 18(C) illustrates R, X, and B from the first prefix 1501(A) being used to extend the reg field 1644 of the MOD R/M byte 1602 and the index field 1654 and base field 1656 when the SIB byte 1604 being used for memory addressing. FIG. 18(D) illustrates B from the first prefix 1501(A) being used to extend the reg field 1644 of the MOD R/M byte 1602 when a register is encoded in the opcode 1503.

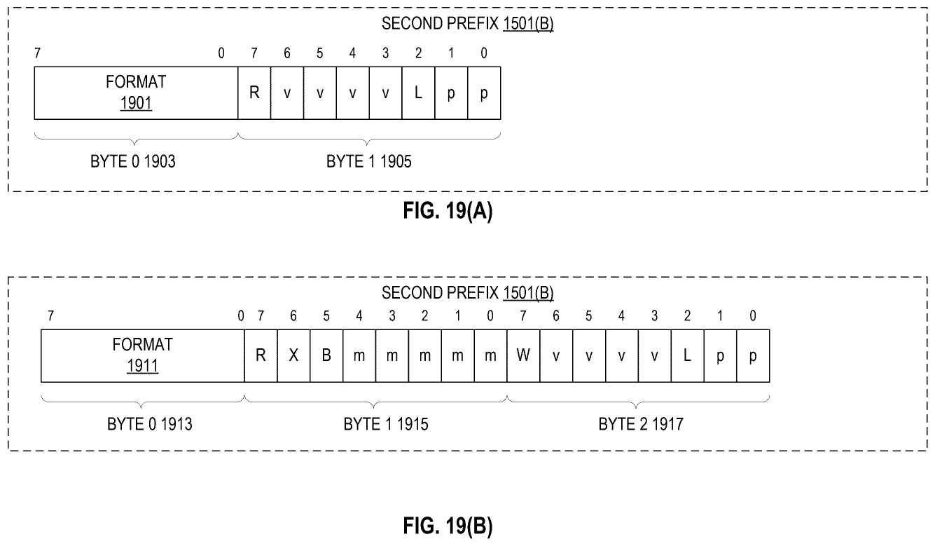

FIGS. 19(A)-(B) illustrate examples of a second prefix 1501(B). In some examples, the second prefix 1501(B) is an example of a VEX prefix. The second prefix 1501(B) encoding allows instructions to have more than two operands, and allows SIMD vector registers (e.g., vector/SIMD registers 1410) to be longer than 64-bits (e.g., 128-bit and 256-bit). The use of the second prefix 1501(B) provides for three-operand (or more) syntax. For example, previous two-operand instructions performed operations such as A=A+B, which overwrites a source operand. The use of the second prefix 1501(B) enables operands to perform nondestructive operations such as A=B+C.

In some examples, the second prefix 1501(B) comes in two forms—a two-byte form and a three-byte form. The two-byte second prefix 1501(B) is used mainly for 128-bit, scalar, and some 256-bit instructions; while the three-byte second prefix 1501(B) provides a compact replacement of the first prefix 1501(A) and 3-byte opcode instructions.

FIG. 19(A) illustrates examples of a two-byte form of the second prefix 1501(B). In one example, a format field 1901 (byte 0 1903) contains the value C5H. In one example, byte 1 1905 includes an “R” value in bit[7]. This value is the complement of the “R” value of the first prefix 1501(A). Bit[2] is used to dictate the length (L) of the vector (where a value of 0 is a scalar or 128-bit vector and a value of 1 is a 256-bit vector). Bits[1:0] provide opcode extensionality equivalent to some legacy prefixes (e.g., 00=no prefix, 01=66H, 10=F3H, and 11=F2H). Bits[6:3] shown as vvvv may be used to: 1) encode the first source register operand, specified in inverted (1s complement) form and valid for instructions with 2 or more source operands; 2) encode the destination register operand, specified in 1s complement form for certain vector shifts; or 3) not encode any operand, the field is reserved and should contain a certain value, such as 1111b.

Instructions that use this prefix may use the MOD R/M R/M field 1646 to encode the instruction operand that references a memory address or encode either the destination register operand or a source register operand.

Instructions that use this prefix may use the MOD R/M reg field 1644 to encode either the destination register operand or a source register operand, or to be treated as an opcode extension and not used to encode any instruction operand.

For instruction syntax that supports four operands, vvvv, the MOD R/M R/M field 1646 and the MOD R/M reg field 1644 encode three of the four operands. Bits[7:4] of the immediate value field 1509 are then used to encode the third source register operand.

FIG. 19(B) illustrates examples of a three-byte form of the second prefix 1501(B). In one example, a format field 1911 (byte 0 1913) contains the value C4H. Byte 1 1915 includes in bits[7:5] “R,” “X,” and “B” which are the complements of the same values of the first prefix 1501(A). Bits[4:0] of byte 1 1915 (shown as mmmmm) include content to encode, as need, one or more implied leading opcode bytes. For example, 00001 implies a 0FH leading opcode, 00010 implies a 0F38H leading opcode, 00011 implies a 0F3AH leading opcode, etc.

Bit[7] of byte 2 1917 is used like W of the first prefix 1501(A) including helping to determine promotable operand sizes. Bit[2] is used to dictate the length (L) of the vector (where a value of 0 is a scalar or 128-bit vector and a value of 1 is a 256-bit vector). Bits[1:0] provide opcode extensionality equivalent to some legacy prefixes (e.g., 00=no prefix, 01=66H, 10=F3H, and 11=F2H). Bits[6:3], shown as vvvv, may be used to: 1) encode the first source register operand, specified in inverted (1s complement) form and valid for instructions with 2 or more source operands; 2) encode the destination register operand, specified in 1s complement form for certain vector shifts; or 3) not encode any operand, the field is reserved and should contain a certain value, such as 1111b.

Instructions that use this prefix may use the MOD R/M R/M field 1646 to encode the instruction operand that references a memory address or encode either the destination register operand or a source register operand.

Instructions that use this prefix may use the MOD R/M reg field 1644 to encode either the destination register operand or a source register operand, or to be treated as an opcode extension and not used to encode any instruction operand.

For instruction syntax that supports four operands, vvvv, the MOD R/M R/M field 1646, and the MOD R/M reg field 1644 encode three of the four operands. Bits[7:4] of the immediate value field 1509 are then used to encode the third source register operand.

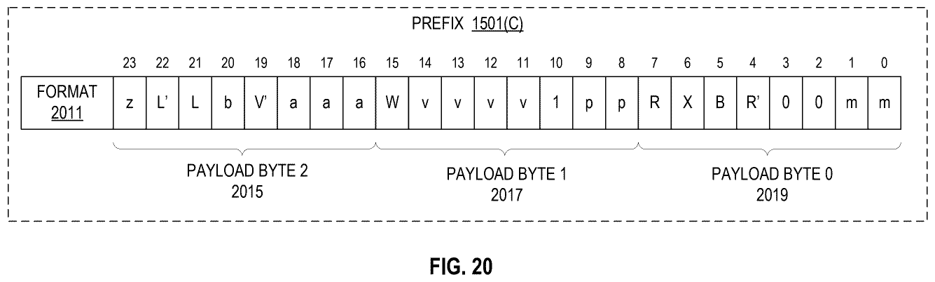

FIG. 20 illustrates examples of a third prefix 1501(C). In some examples, the third prefix 1501(C) is an example of an EVEX prefix. The third prefix 1501(C) is a four-byte prefix.

The third prefix 1501(C) can encode 32 vector registers (e.g., 128-bit, 256-bit, and 512-bit registers) in 64-bit mode. In some examples, instructions that utilize a writemask/opmask (see discussion of registers in a previous figure, such as FIG. 14) or predication utilize this prefix. Opmask register allows for conditional processing or selection control. Opmask instructions, whose source/destination operands are opmask registers and treat the content of an opmask register as a single value, are encoded using the second prefix 1501(B).

The third prefix 1501(C) may encode functionality that is specific to instruction classes (e.g., a packed instruction with “load+op” semantic can support embedded broadcast functionality, a floating-point instruction with rounding semantic can support static rounding functionality, a floating-point instruction with non-rounding arithmetic semantic can support “suppress all exceptions” functionality, etc.).

The first byte of the third prefix 1501(C) is a format field 2011 that has a value, in one example, of 62H. Subsequent bytes are referred to as payload bytes 2015-2019 and collectively form a 24-bit value of P[23:0] providing specific capability in the form of one or more fields (detailed herein).

In some examples, P[1:0] of payload byte 2019 are identical to the low two mm bits. P[3:2] are reserved in some examples. Bit P[4] (R′) allows access to the high 16 vector register set when combined with P[7] and the MOD R/M reg field 1644. P[6] can also provide access to a high 16 vector register when SIB-type addressing is not needed. P[7:5] consist of R, X, and B which are operand specifier modifier bits for vector register, general purpose register, memory addressing and allow access to the next set of 8 registers beyond the low 8 registers when combined with the MOD R/M register field 1644 and MOD R/M R/M field 1646. P[9:8] provides opcode extensionality equivalent to some legacy prefixes (e.g., 00=no prefix, 01=66H, 10=F3H, and 11=F2H). P[10] in some examples is a fixed value of 1. P[14:11], shown as vvvv, may be used to: 1) encode the first source register operand, specified in inverted (1s complement) form and valid for instructions with 2 or more source operands; 2) encode the destination register operand, specified in 1s complement form for certain vector shifts; or 3) not encode any operand, the field is reserved and should contain a certain value, such as 1111b.

P[15] is like W of the first prefix 1501(A) and second prefix 1511(B) and may serve as an opcode extension bit or operand size promotion.

P[18:16] specify the index of a register in the opmask (writemask) registers (e.g., writemask/predicate registers 1415). In one example, the specific value aaa=000 has a special behavior implying no opmask is used for the particular instruction (this may be implemented in a variety of ways including the use of an opmask hardwired to all ones or hardware that bypasses the masking hardware). When merging, vector masks allow any set of elements in the destination to be protected from updates during the execution of any operation (specified by the base operation and the augmentation operation); in other one example, preserving the old value of each element of the destination where the corresponding mask bit has a 0. In contrast, when zeroing vector masks allow any set of elements in the destination to be zeroed during the execution of any operation (specified by the base operation and the augmentation operation); in one example, an element of the destination is set to 0 when the corresponding mask bit has a 0 value. A subset of this functionality is the ability to control the vector length of the operation being performed (that is, the span of elements being modified, from the first to the last one); however, it is not necessary that the elements that are modified be consecutive. Thus, the opmask field allows for partial vector operations, including loads, stores, arithmetic, logical, etc. While examples are described in which the opmask field's content selects one of a number of opmask registers that contains the opmask to be used (and thus the opmask field's content indirectly identifies that masking to be performed), alternative examples instead or additional allow the mask write field's content to directly specify the masking to be performed.

P[19] can be combined with P[14:11] to encode a second source vector register in a non-destructive source syntax which can access an upper 16 vector registers using P[19]. P[20] encodes multiple functionalities, which differ across different classes of instructions and can affect the meaning of the vector length/rounding control specifier field (P[22:21]). P[23] indicates support for merging-writemasking (e.g., when set to 0) or support for zeroing and merging-writemasking (e.g., when set to 1).

Example examples of encoding of registers in instructions using the third prefix 1501(C) are detailed in the following tables.

TABLE 1
32-Register Support in 64-bit Mode

| | 4 | 3 | [2:0] | REG. TYPE | COMMON USAGES |
|---|---|---|---|---|---|
| REG | R′ | R | MOD R/M | GPR, Vector | Destination or Source |
| | | | reg | | |
| VVVV | V′ | vvvv | | GPR, Vector | 2nd Source or |
| | | | | | Destination |
| RM | X | B | MOD R/M | GPR, Vector | 1st Source or |
| | | | R/M | | Destination |
| BASE | 0 | B | MOD R/M | GPR | Memory addressing |
| | | | R/M | | |
| INDEX | 0 | X | SIB.index | GPR | Memory addressing |
| VIDX | V′ | X | SIB.index | Vector | VSIB memory |
| | | | | | addressing |

TABLE 2
Encoding Register Specifiers in 32-bit Mode

| | [2:0] | REG. TYPE | COMMON USAGES |
|---|---|---|---|
| REG | MOD R/M reg | GPR, Vector | Destination or Source |
| VVVV | vvvv | GPR, Vector | 2^{nd} Source or Destination |
| RM | MOD R/M R/M | GPR, Vector | 1^{st} Source or Destination |
| BASE | MOD R/M R/M | GPR | Memory addressing |
| INDEX | SIB.index | GPR | Memory addressing |
| VIDX | SIB.index | Vector | VSIB memory addressing |

TABLE 3
Opmask Register Specifier Encoding

| | [2:0] | REG. TYPE | COMMON USAGES |
|---|---|---|---|
| REG | MOD R/M Reg | k0-k7 | Source |
| VVVV | vvvv | k0-k7 | 2^{nd} Source |
| RM | MOD R/M R/M | k0-k7 | 1^{st} Source |
| {k1} | aaa | k0-k7 | Opmask |

Program code may be applied to input information to perform the functions described herein and generate output information. The output information may be applied to one or more output devices, in known fashion. For purposes of this application, a processing system includes any system that has a processor, such as, for example, a digital signal processor (DSP), a microcontroller, an application specific integrated circuit (ASIC), a field programmable gate array (FPGA), a microprocessor, or any combination thereof.

The program code may be implemented in a high-level procedural or object-oriented programming language to communicate with a processing system. The program code may also be implemented in assembly or machine language, if desired. In fact, the mechanisms described herein are not limited in scope to any particular programming language. In any case, the language may be a compiled or interpreted language.

Examples of the mechanisms disclosed herein may be implemented in hardware, software, firmware, or a combination of such implementation approaches. Examples may be implemented as computer programs or program code executing on programmable systems comprising at least one processor, a storage system (including volatile and non-volatile memory and/or storage elements), at least one input device, and at least one output device.

One or more aspects of at least one example may be implemented by representative instructions stored on a machine-readable medium which represents various logic within the processor, which when read by a machine causes the machine to fabricate logic to perform the techniques described herein. Such representations, known as “intellectual property (IP) cores” may be stored on a tangible, machine readable medium and supplied to various customers or manufacturing facilities to load into the fabrication machines that make the logic or processor.

Such machine-readable storage media may include, without limitation, non-transitory, tangible arrangements of articles manufactured or formed by a machine or device, including storage media such as hard disks, any other type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), phase change memory (PCM), magnetic or optical cards, or any other type of media suitable for storing electronic instructions.

Accordingly, examples also include non-transitory, tangible machine-readable media containing instructions or containing design data, such as Hardware Description Language (HDL), which defines structures, circuits, apparatuses, processors, and/or system features described herein. Such examples may also be referred to as program products.

### Emulation (Including Binary Translation, Code Morphing, Etc.).

In some cases, an instruction converter may be used to convert an instruction from a source instruction set architecture to a target instruction set architecture. For example, the instruction converter may translate (e.g., using static binary translation, dynamic binary translation including dynamic compilation), morph, emulate, or otherwise convert an instruction to one or more other instructions to be processed by the core. The instruction converter may be implemented in software, hardware, firmware, or a combination thereof. The instruction converter may be on processor, off processor, or part on and part off processor.

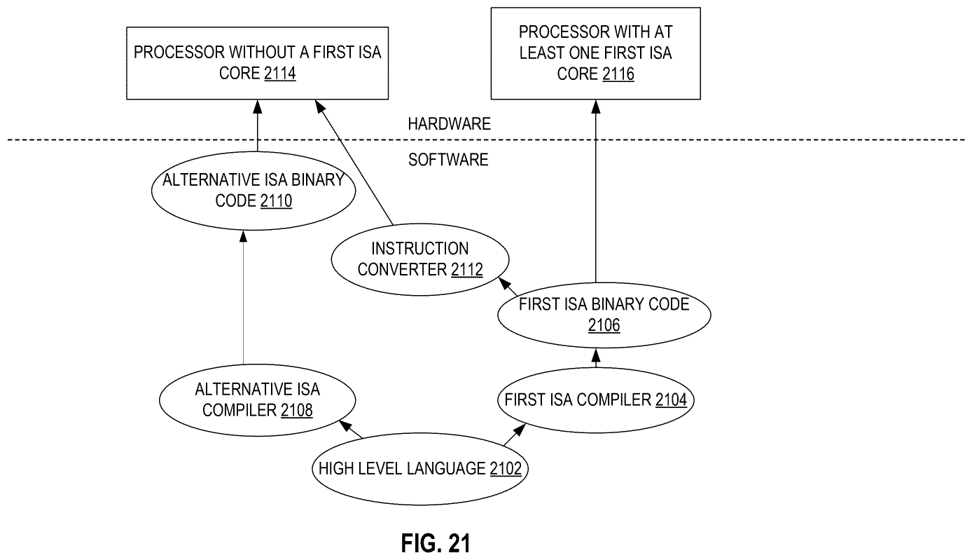

FIG. 21 is a block diagram illustrating the use of a software instruction converter to convert binary instructions in a source ISA to binary instructions in a target ISA according to examples. In the illustrated example, the instruction converter is a software instruction converter, although alternatively the instruction converter may be implemented in software, firmware, hardware, or various combinations thereof. FIG. 21 shows a program in a high-level language 2102 may be compiled using a first ISA compiler 2104 to generate first ISA binary code 2106 that may be natively executed by a processor with at least one first ISA core 2116. The processor with at least one first ISA core 2116 represents any processor that can perform substantially the same functions as an Intel® processor with at least one first ISA core by compatibly executing or otherwise processing (1) a substantial portion of the first ISA or (2) object code versions of applications or other software targeted to run on an Intel processor with at least one first ISA core, in order to achieve substantially the same result as a processor with at least one first ISA core. The first ISA compiler 2104 represents a compiler that is operable to generate the first ISA binary code 2106 (e.g., object code) that can, with or without additional linkage processing, be executed on the processor with at least one first ISA core 2116. Similarly, FIG. 21 shows the program in the high-level language 2102 may be compiled using an alternative ISA compiler 2108 to generate alternative ISA binary code 2110 that may be natively executed by a processor without a first ISA core 2114. The instruction converter 2112 is used to convert the first ISA binary code 2106 into code that may be natively executed by the processor without a first ISA core 2114. This converted code is not necessarily to be the same as the alternative ISA binary code 2110; however, the converted code will accomplish the general operation and be made up of instructions from the alternative ISA. Thus, the instruction converter 2112 represents software, firmware, hardware, or a combination thereof that, through emulation, simulation, or any other process, allows a processor or other electronic device that does not have a first ISA processor or core to execute the first ISA binary code 2106.

Components, features, and details described for any of FIGS. 1 and 5-9 may also optionally apply to any of FIGS. 3-4. Components, features, and details described for any of the apparatus disclosed herein (e.g., chip 335, trusted IO access control 508, etc.) may optionally apply to any of the methods disclosed herein (e.g., method 440), which in embodiments may optionally be performed by and/or with such processors. Any of the apparatus described herein in embodiments may optionally be included in any of the systems disclosed herein.

References to “one example,” “an example,” etc., indicate that the example described may include a particular feature, structure, or characteristic, but every example may not necessarily include the particular feature, structure, or characteristic. Moreover, such phrases do not necessarily refer to the same example. Further, when a particular feature, structure, or characteristic is described in connection with an example, it is submitted that it is within the knowledge of one skilled in the art to affect such feature, structure, or characteristic in connection with other examples whether explicitly described.

Processor components disclosed herein may be said and/or claimed to be operative, operable, capable, able, configured adapted, or otherwise to perform an operation. For example, a decoder may be said and/or claimed to decode an instruction, an execution unit may be said and/or claimed to store a result, or the like. As used herein, these expressions refer to the characteristics, properties, or attributes of the components when in a powered-off state, and do not imply that the components or the device or apparatus in which they are included is currently powered on or operating. For clarity, it is to be understood that the processors and apparatus claimed herein are not claimed as being powered on or running.

In the description and claims, the terms “coupled” and/or “connected,” along with their derivatives, may have been used. These terms are not intended as synonyms for each other. Rather, in embodiments, “connected” may be used to indicate that two or more elements are in direct physical and/or electrical contact with each other. “Coupled” may mean that two or more elements are in direct physical and/or electrical contact with each other. However, “coupled” may also mean that two or more elements are not in direct contact with each other, yet still co-operate or interact with each other. For example, an execution unit may be coupled with a register and/or a decode unit through one or more intervening components. In the figures, arrows are used to show connections and couplings.

Some embodiments include an article of manufacture (e.g., a computer program product) that includes a machine-readable medium. The medium may include a mechanism that provides, for example stores, information in a form that is readable by the machine. The machine-readable medium may provide, or have stored thereon, an instruction or sequence of instructions, that if and/or when executed by a machine are operative to cause the machine to perform and/or result in the machine performing one or operations, methods, or techniques disclosed herein.

In some embodiments, the machine-readable medium may include a tangible and/or non-transitory machine-readable storage medium. For example, the non-transitory machine-readable storage medium may include a floppy diskette, an optical storage medium, an optical disk, an optical data storage device, a CD-ROM, a magnetic disk, a magneto-optical disk, a read only memory (ROM), a programmable ROM (PROM), an erasable-and-programmable ROM (EPROM), an electrically-erasable-and-programmable ROM (EEPROM), a random access memory (RAM), a static-RAM (SRAM), a dynamic-RAM (DRAM), a Flash memory, a phase-change memory, a phase-change data storage material, a non-volatile memory, a non-volatile data storage device, a non-transitory memory, a non-transitory data storage device, or the like. The non-transitory machine-readable storage medium does not consist of a transitory propagated signal. In some embodiments, the storage medium may include a tangible medium that includes solid-state matter or material, such as, for example, a semiconductor material, a phase change material, a magnetic solid material, a solid data storage material, etc. Alternatively, a non-tangible transitory computer-readable transmission media, such as, for example, an electrical, optical, acoustical, or other form of propagated signals-such as carrier waves, infrared signals, and digital signals, may optionally be used.

Examples of suitable machines include, but are not limited to, a general-purpose processor, a special-purpose processor, a digital logic circuit, an integrated circuit, or the like. Still other examples of suitable machines include a computer system or other electronic device that includes a processor, a digital logic circuit, or an integrated circuit. Examples of such computer systems or electronic devices include, but are not limited to, desktop computers, laptop computers, notebook computers, tablet computers, netbooks, smartphones, cellular phones, servers, network devices (e.g., routers and switches.), Mobile Internet devices (MIDs), media players, smart televisions, nettops, set-top boxes, and video game controllers.

Moreover, in the various examples described above, unless specifically noted otherwise, disjunctive language such as the phrase “at least one of A, B, or C” or “A, B, and/or C” is intended to be understood to mean either A, B, or C, or any combination thereof (i.e. A and B, A and C, B and C, and A, B and C).

In the description above, specific details have been set forth to provide a thorough understanding of the embodiments. However, other embodiments may be practiced without some of these specific details. Various modifications and changes may be made thereunto without departing from the broader spirit and scope of the disclosure as set forth in the claims. The specification and drawings are, accordingly, to be regarded in an illustrative rather than a restrictive sense. The scope of the invention is not to be determined by the specific examples provided above, but only by the claims below. In other instances, well-known circuits, structures, devices, and operations have been shown in block diagram form and/or without detail to avoid obscuring the understanding of the description.

### EXAMPLE EMBODIMENTS

The following examples pertain to further embodiments. Specifics in the examples may be used anywhere in one or more embodiments.

Example 1 is an apparatus including a controller to receive a first trusted write from at least a portion of a trusted input/output (IO) device to private memory of a trusted virtual machine (TVM), and an IO processor coupled with the controller, the IO processor to drop the first trusted write and block, based on the first trusted write being dropped, a subsequent trusted write from said at least the portion of the trusted IO device to a completion indicator in the private memory of the TVM.

Example 2 includes the apparatus of Example 1, further including an IO memory management unit (IOMMU) coupled with the IO processor. The IOMMU is to attempt to translate a device virtual address associated with the first trusted write to a host physical address. The IO processor is to drop the first trusted write based on an exceptional condition raised during the attempt to translate the device virtual address to the host physical address.

Example 3 includes the apparatus of any one of Examples 1 to 2, where the first trusted write is a posted write.

Example 4 includes the apparatus of any one of Examples 1 to 3, where said at least the portion of the trusted IO device is a trusted execution environment input/output device interface (TDI).

Example 5 includes the apparatus of any one of Examples 1 to 4, where the controller is a Peripheral Component Interconnect Express (PCIe) Integrity and Data Encryption (IDE) controller.

Example 6 includes the apparatus of any one of Examples 1 to 5, where said at least the portion of the trusted IO device is or includes a trusted execution environment input/output device interface (TDI). Also optionally where the IO processor is to block, based on the first trusted write being dropped, all trusted writes received from the TDI after the first trusted write.

Example 7 includes the apparatus of Example 6, where the IO processor is to block, based on the first trusted write being dropped, all trusted reads received from the TDI after the first trusted write.

Example 8 includes the apparatus of any one of Examples 6 to 7, where the IO processor, based on the first trusted write being dropped, is not to block non-trusted writes received from the TDI after the first trusted write.

Example 9 includes the apparatus of any one of Examples 1 to 5, where said at least the portion of the trusted IO device is or includes a trusted execution environment input/output device interface (TDI). Also optionally where the IO processor is to block, based on the first trusted write being dropped, all trusted writes received after the first trusted write over an Integrity and Data Encryption (IDE) selective stream over which the first trusted write was received.

Example 10 includes the apparatus of any one of Examples 1 to 5, where the IO processor is to block, based on the first trusted write being dropped, all trusted writes received from the trusted IO device after the first trusted write.

Example 11 is a method including receiving a first trusted write from at least a portion of a trusted input/output (IO) device to private memory of a trusted virtual machine (TVM), dropping the first trusted write, and blocking, based on the first trusted write being dropped, a subsequent trusted write from said at least the portion of the trusted IO device to a completion indicator in the private memory of the TVM.

Example 12 includes the method of Example 11, where the receiving includes receiving the first trusted write from a trusted execution environment input/output device interface (TDI). Also optionally where the blocking includes blocking all trusted writes received from the TDI after the first trusted write.

Example 13 includes the method of Example 11, where the receiving includes receiving the first trusted write from a trusted execution environment input/output device interface (TDI). Also optionally where the blocking includes blocking all trusted writes received after the first trusted write over an Integrity and Data Encryption (IDE) selective stream over which the first trusted write was received.

Example 14 includes the method of any one of Examples 11 to 13, where the receiving the first trusted write includes receiving a posted write. Also optionally further including detecting an exceptional condition during an attempt to translate a device virtual address associated with the first trusted write to a host physical address. Also optionally where the dropping the first trusted write is based on the detection of the exceptional condition.

Example 15 includes the method of any one of Examples 11 to 14, further including, based on the first trusted write being dropped, causing a subsequent trusted read from said at least the portion of the trusted IO device to return an unsuccessful response.

Example 16 is a non-transitory machine-readable storage medium, the non-transitory machine-readable storage medium storing instructions that if executed by a machine are to cause the machine to perform operations including performing one or more operations to unbind at least a portion of a trusted IO device from a trusted virtual machine and to control an IO processor to stop blocking trusted writes from said at least the portion of the trusted IO device.

Example 17 includes the non-transitory machine-readable storage medium of Example 16, where the instructions to control the IO processor to stop blocking the trusted writes from said at least the portion of the trusted IO device further comprise instructions that if executed by the machine are to cause the machine to send a requester identifier (RID) identifying said at least the portion of the trusted IO device to the IO processor.

Example 18 includes the non-transitory machine-readable storage medium of Example 16, where the instructions to control the IO processor to stop blocking the trusted writes from said at least the portion of the trusted IO device further comprise instructions that if executed by the machine are to cause the machine to send a stream identifier for an Integrity and Data Encryption (IDE) selective stream to the to the IO processor.

Example 19 includes the non-transitory machine-readable storage medium of any one of Examples 16 to 18, where the instructions to performing the one or more operations to unbind said at least a portion of the trusted IO device from the trusted virtual machine further comprise instructions that if executed by the machine are to cause the machine to invalidate a plurality of translations in a translation lookaside buffer (TLB) of a processor and invalidate a plurality of translations in a TLB of an input-output memory management unit (IOMMU).

Example 20 includes the non-transitory machine-readable storage medium of any one of Examples 16 to 19, where the instructions to performing the one or more operations to unbind said at least a portion of the trusted IO device from the trusted virtual machine further comprise instructions that if executed by the machine are to cause the machine to stop and unlock said at least a portion of the trusted IO device.

Example 21 is an apparatus operative to perform the method of any one of Examples 11 to 15.

Example 22 is an apparatus that includes means for performing the method of any one of Examples 11 to 15.

Example 23 is an apparatus that includes any combination of modules and/or units and/or logic and/or circuitry and/or means operative to perform the method of any one of Examples 11 to 15.

Example 24 is an apparatus that includes a controller to receive a first trusted write from at least a portion of a trusted input/output (IO) device. The apparatus also includes an IO processor coupled with the controller. The IO processor to drop the first trusted write and block, based on the first trusted write being dropped, a subsequent trusted write from said at least the portion of the trusted IO device. Other apparatus, methods, and systems are also disclosed.

What is claimed is:

1. An apparatus comprising:
a controller to receive a first trusted write from at least a portion of a trusted input/output (IO) device to private memory of a trusted virtual machine (TVM);
an IO processor coupled with the controller, the IO processor to:
drop the first trusted write; and
block, based on the first trusted write being dropped, a subsequent trusted write from said at least the portion of the trusted IO device to a completion indicator in the private memory of the TVM.

2. The apparatus of claim 1, further comprising an IO memory management unit (IOMMU) coupled with the IO processor, the IOMMU to attempt to translate a device virtual address associated with the first trusted write to a host physical address, wherein the IO processor is to drop the first trusted write based on an exceptional condition raised during the attempt to translate the device virtual address to the host physical address.

3. The apparatus of claim 1, wherein the first trusted write is a posted write.

4. The apparatus of claim 1, wherein said at least the portion of the trusted IO device is a trusted execution environment input/output device interface (TDI).

5. The apparatus of claim 1, wherein the controller is a Peripheral Component Interconnect Express (PCIe) Integrity and Data Encryption (IDE) controller.

6. The apparatus of claim 1, wherein said at least the portion of the trusted IO device is a trusted execution environment input/output device interface (TDI), and wherein the IO processor is to block, based on the first trusted write being dropped, all trusted writes received from the TDI after the first trusted write.

7. The apparatus of claim 6, wherein the IO processor is to block, based on the first trusted write being dropped, all trusted reads received from the TDI after the first trusted write.

8. The apparatus of claim 6, wherein the IO processor, based on the first trusted write being dropped, is not to block non-trusted writes received from the TDI after the first trusted write.

9. The apparatus of claim 1, wherein said at least the portion of the trusted IO device is a trusted execution environment input/output device interface (TDI), and wherein the IO processor is to block, based on the first trusted write being dropped, all trusted writes received after the first trusted write over an Integrity and Data Encryption (IDE) selective stream over which the first trusted write was received.

10. The apparatus of claim 1, wherein the IO processor is to block, based on the first trusted write being dropped, all trusted writes received from the trusted IO device after the first trusted write.

11. A method comprising:
receiving a first trusted write from at least a portion of a trusted input/output (IO) device to private memory of a trusted virtual machine (TVM);
dropping the first trusted write; and
blocking, based on the first trusted write being dropped, a subsequent trusted write from said at least the portion of the trusted IO device to a completion indicator in the private memory of the TVM.

12. The method of claim 11, wherein the receiving comprises receiving the first trusted write from a trusted execution environment input/output device interface (TDI), and wherein the blocking comprises blocking all trusted writes received from the TDI after the first trusted write.

13. The method of claim 11, wherein the receiving comprises receiving the first trusted write from a trusted execution environment input/output device interface (TDI), and wherein the blocking comprises blocking all trusted writes received after the first trusted write over an Integrity and Data Encryption (IDE) selective stream over which the first trusted write was received.

14. The method of claim 11, wherein the receiving the first trusted write comprises receiving a posted write, further comprising detecting an exceptional condition during an attempt to translate a device virtual address associated with the first trusted write to a host physical address, and wherein the dropping the first trusted write is based on the detection of the exceptional condition.

15. The method of claim 11, further comprising, based on the first trusted write being dropped, causing a subsequent trusted read from said at least the portion of the trusted IO device to return an unsuccessful response.

16. A non-transitory machine-readable storage medium, the non-transitory machine-readable storage medium storing instructions that if executed by a machine are to cause the machine to perform operations, including to:
perform one or more operations to unbind at least a portion of a trusted IO device from a trusted virtual machine; and
control an IO processor to stop blocking trusted writes from said at least the portion of the trusted IO device.

17. The non-transitory machine-readable storage medium of claim 16, wherein the instructions to control the IO processor to stop blocking the trusted writes from said at least the portion of the trusted IO device further comprise instructions that if executed by the machine are to cause the machine to send a requester identifier (RID) identifying said at least the portion of the trusted IO device to the IO processor.

18. The non-transitory machine-readable storage medium of claim 16, wherein the instructions to control the IO processor to stop blocking the trusted writes from said at least the portion of the trusted IO device further comprise instructions that if executed by the machine are to cause the machine to send a stream identifier for an Integrity and Data Encryption (IDE) selective stream to the to the IO processor.

19. The non-transitory machine-readable storage medium of claim 16, wherein the instructions to perform the one or more operations to unbind said at least a portion of the trusted IO device from the trusted virtual machine further comprise instructions that if executed by the machine are to cause the machine to invalidate a plurality of translations in a translation lookaside buffer (TLB) of a processor and invalidate a plurality of translations in a TLB of an input-output memory management unit (IOMMU).

20. The non-transitory machine-readable storage medium of claim 16, wherein the instructions to perform the one or more operations to unbind said at least a portion of the trusted IO device from the trusted virtual machine further comprise instructions that if executed by the machine are to cause the machine to stop and unlock said at least a portion of the trusted IO device.
